(19) United States
(12) Patent Application Publication
(10) Pub. No.: US 2025/0069521 A1
(43) Pub. Date: Feb. 27, 2025

(54) SYSTEMS AND METHODS FOR PROVIDING REAL-TIME INTERACTIVE TEACHING AND LEARNING ENVIRONMENTS

(71) Applicants: Ryan Dehmoubed, Cardiff, CA (US); Philippe Rivard, Carlsbad, CA (US)

(72) Inventors: Ryan Dehmoubed, Cardiff, CA (US); Philippe Rivard, Carlsbad, CA (US)

(21) Appl. No.: 18/237,905

(22) Filed: Aug. 25, 2023

(51) Int. Cl. G09B 19/00; G06F 8/33; G09B 7/00

(52) U.S. Cl. CPC G09B 19/0053; G06F 8/33; G09B 7/00

(57) ABSTRACT

A method and system for distributing content in a real-time interactive environment to one or more computing devices configured to include, via a graphical user interface (GUI), an editor to display, arrange, edit, debug, and interpret, run, execute, or compile code provided within the editor, and then output result feedback to the user via the GUI, the code being modifiable text or a plurality of arrangeable visual objects within the GUI, and the editor being configured to include an integrated development environment (IDE) to edit, interpret and run code within the real-time interactive environment, the IDE further configured to provide visual cues to assist in viewing, arranging, and editing the code.

### FIELD OF THE DISCLOSURE

The embodiments described herein relate to interactive systems and methods, and in particular, systems and methods for providing real-time interactive teaching and learning environments.

### BACKGROUND

Today numerous remotely accessible instructional platforms exist for professionals, students, teachers, and those looking to learn through an online learning platform, program, resource, or curriculum. Moreover, for local settings, other instructional platforms exists to distribute instructional content (reading materials, media, guides, references, resources, etc.,) to a group or classroom within a local network (e.g., intranet, hotspot, etc.,). Some of these platforms, designed for a general audience, distribute reading materials and multimedia for learners to review, use as a reference, and multiple choice or fill-in questions as tests or quizzes within the same platform. Other platforms handoff or utilize a different (e.g., test taking) platform or resource to administer tests or quizzes. While instructional and test taking platforms provide learners with resources to study, prepare, and take tests and quizzes, they have a few problems. One problem with existing instructional platforms is the inability to alter or revise elements within the question and test the revision. As an example, instructional platforms lack the ability to varying materials to understand stress levels for different materials pertaining to a question on the stress of steel at a certain temperature and pressure, or varying the temperature and pressure to cycle through materials that provide the equivalent stress of steel provided at initial conditions. Another problem with existing instructional platforms is the inability to understand components of the problem in the proper technological or scientific environment. For example, in computer programming questions, code is provided to users as static and/or standard text, many environmental features that distinguish the code and functions such as syntax, libraries, functions, and other operators are not readily recognizable for making inferences on the nature of the code and subsequently obtaining a correct answer quickly. Another problem with existing instructional platforms is the inability to allow users to participate in a multi-user real-time environment that favors interaction and competition with other participants to stimulate test takers to improve their speed and answer more questions correctly to rise up in rankings among their group of test takers.

### SUMMARY

In one embodiment, the disclosed subject matter relates to a method that includes: distributing content, by a computing system, over a network to computing devices, the distributed content including at least one of text and code, providing each of the computing devices with an editor to edit, display, and process the distributed content in real-time, displaying a first content of the distributed content on at least one computing device, where the first content of the distributed content is displayed concurrently each computing device.

In one embodiment, the disclosed subject matter relates to a non-transitory computer-readable medium having instructions that may be used and executed by one or more processors of a processing system to perform operations including: distributing content, by a computing system, over a network to computing devices, the distributed content including at least one of text and code, providing each of the computing devices with an editor to edit, display, and process the distributed content in real-time, displaying a first content of the distributed content on at least one computing device, where the first content of the distributed content is displayed concurrently each computing device.

In one embodiment, the disclosed subject matter relates to a computing system having: a network interface configured to communicate with computing devices, a processor, and memory in communication with the processor and storing instructions that, when executed by the processor, cause the computing system to: retrieve content from a database, the content configured to include at least one of text and code, and distribute the content to each computing device, where the distributed content is displayed on at least one computing device, where the distributed content is displayed concurrently on each computing device, and where each computing device includes an editor to edit, display, and process the distributed content in real-time.

It is understood that other configurations of the present disclosure will become readily apparent to those skilled in the art from the following detailed description, wherein various configurations of the present disclosure are shown and described by way of illustration. As will be realized, the present disclosure of other different configurations and its several details are capable of modifications in various other respects, all without departing from the subject technology. Accordingly, the drawings and the detailed description are to be regarded as illustrative in nature and not restrictive.

### BRIEF DESCRIPTION OF THE DRAWINGS

Certain features of the present disclosure are set forth in the appended claims. However, for purpose of explanation, several implementations of the present disclosure are set forth in the following figures. At least one embodiment of the present invention will now be described with reference to the drawings and appendices, in which:

FIG. 1 illustrates an example network environment configured for implementing an example server to client communication system for providing real-time interactive teaching and learning environments, according to some of the disclosed embodiments;

FIG. 2A illustrates a block diagram of an example client computing device and example server configured for the network environment of FIG. 1, according to some of the disclosed embodiments;

FIG. 2B illustrates a block diagram of an example resource provider device and example client computing device configured for the network environment of FIG. 1, according to some of the disclosed embodiments;

FIGS. 3A-3D illustrate a block diagram of an example graphical user interface for a learner in a real-time interactive teaching and learning environment, according to some of the disclosed embodiments;

FIG. 3E illustrates a block diagram of an example user interface for a resource provider in a real-time interactive teaching and learning environment, according to some of the disclosed embodiments;

FIGS. 4A-4E illustrates a block diagram of an example user interface for a resource provider to create content for a real-time interactive teaching and learning environment, according to some of the disclosed embodiments;

FIG. 5 illustrates a block diagram of an example block coding user interface for a learner in a real-time interactive teaching and learning environment, according to some of the disclosed embodiments;

FIG. 6A illustrates an example flow chart showing a method of distributing content for providing real-time interactive teaching and learning environments in accordance with one or more embodiments of the present disclosure;

FIG. 6B illustrates an example flow chart showing a method of distributing content for providing real-time interactive teaching and learning environments in accordance with one or more embodiments of the present disclosure; and

FIG. 6C illustrates an example flow chart showing a method of distributing content for providing real-time interactive teaching and learning environments in accordance with one or more embodiments of the present disclosure.

The various embodiments will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples. Embodiments of the present disclosure and their advantages are best understood by referring to the detailed description that follows.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

Various features of the present disclosure will now be described and is not intended to be limited to the embodiments shown herein. Modifications to these features and embodiments will be readily apparent to those skilled in the art, and the principles defined herein may be applied to other embodiments without departing from the scope of the disclosure.

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Many instructional and testing platforms are available for users on a case by case basis each platform geared for technology, legal, scientific or other area of learning, study, research, simulation, and test taking or preparation through a local network or an online learning platform, program, resource, or curriculum. Some of these platforms, designed for a general audience, distribute reading materials and multimedia for learners to review, use as a reference, and multiple choice or fill-in questions as tests or quizzes within the same platform. Other platforms handoff or utilize a different (e.g., test taking) platform or resource to administer tests or quizzes. One problem learners face during an instructional or testing session is the inability to alter or revise elements within the question and test the revision. Another problem learners face during an instructional or testing session is the inability to understand components of the problem in the proper technological or scientific environment. Still, another problem learners face during an instructional or testing session is the inability to participate in a multi-user real-time environment that favors interaction and competition with other participants to stimulate test takers to improve their speed and answer more questions correctly to rise up in rankings among their group of test takers. Various embodiments of the present disclosure provide a solution to one or more of the above technical problems and others. In some embodiments, the instructional and/or testing platform is configured to include a tool or program (e.g., interactive development environment, or integrated development environment) to enable users to alter or revise elements, code, for example, within the question and test the revision (e.g., interpret or run the code). In certain embodiments, the interactive development environment or integrated development environment is configured to provide users with visual cues, highlighting, tracking, auto-complete, error detection, library or function detection, nested functions, code and operations, as well as the ability to run or interpret the code and an output shell to view the results. This may enable users to see and distinguish environmental features, functions, and changes such as correct syntax, code or other environment libraries, functions, and other operators not readily recognizable for making inferences on the nature of the problem (e.g., code). In many embodiments, the instructional and/or testing platform is configured to allow multi-user and/or real-time environment to facilitate interaction and competition with other participants to stimulate users to improve their speed, enhance their knowledge, and answer more questions or solve more difficult problems. In some embodiments, the instructional and/or testing platform may be configured to provide visual building blocks that encapsulate functions, routines, or programs to enable users to investigate different outcomes using various ordering or combinations of building blocks.

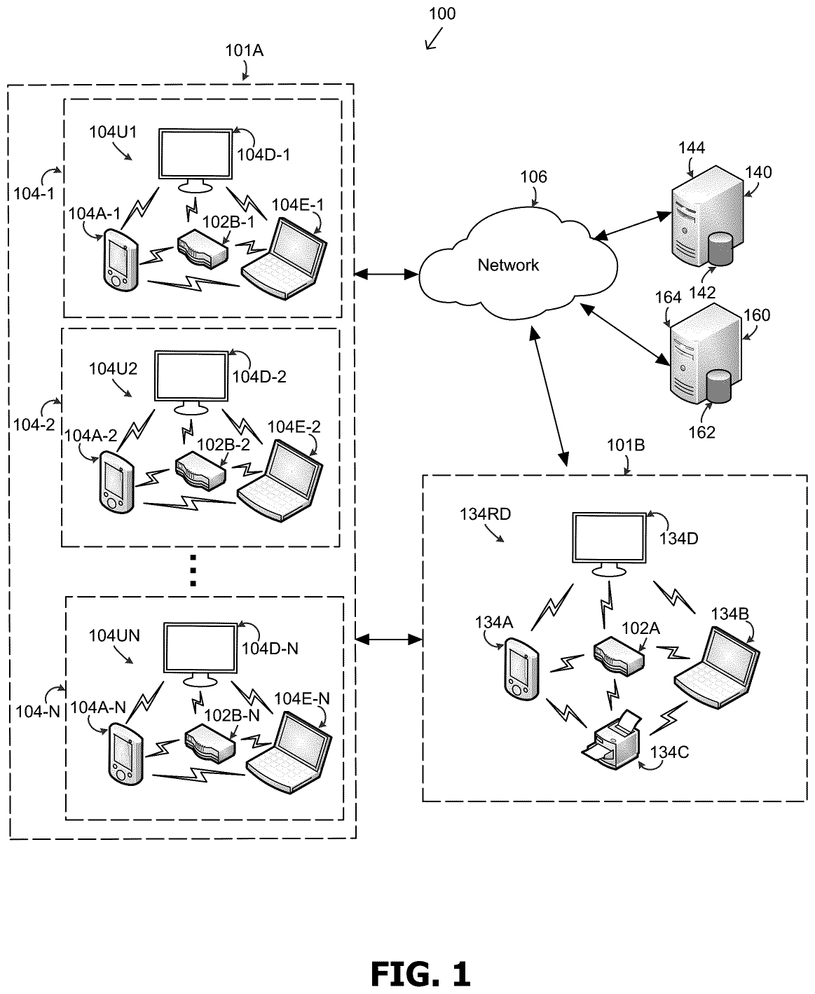

FIG. 1 illustrates an example network environment configured for implementing an example server to client communication system for providing real-time interactive teaching and learning environments, according to some of the disclosed embodiments. As shown in FIG. 1, the example network environment 100 may include wireless local area network 101A, wireless local area network 101B, network 106, wireless access points 102A and 102B-1, 102B-2 . . . 102B-N (hereinafter “102B”), and servers 140 and 160 may include computing devices 144 and 164 and computer-readable storage devices 142 and 162. In some embodiments, the example network environment 100 may be a distributed client/server system that spans one or more networks such as, for example, network 106. Network 106 may be a large computer network such as, for example, wide area network (WAN), the Internet, a cellular network, or a combination thereof connecting any number of mobile clients, fixed clients, and servers. Further, the network 106 may include, but is not limited to, any of the following network topologies, including a bus network, a star network, a ring network, a mesh network, a star-bus network, tree or hierarchical network, and the like. In some aspects, communication between wireless local area network 101A, wireless local area network 101B, and servers 140 and 160 may occur via a virtual private network (VPN), Secure Shell (SSH) tunnel, or other secure network connection. In some aspects, network 106 may further include a corporate network (e.g., intranet), a local hotspot, or a corporate hotspot and one or more wireless access points. The network 106 may include any computer network or combination thereof. The network 106 is not limited, however, to connections coupling separate computer units. Rather, the network 106 may also comprise subsystems that transfer data between servers or computing devices.

For example, by way of illustration only and not by way of limitation, wireless local area network area 101A may include wireless computing nodes 104-1, 104-2 . . . 104-N(hereinafter “104LN”), each wireless computing node 104LN may include one or more user devices (hereinafter “104UD”) assigned to a user, for example, user 104U1 may have one or more smartphones 104A-1, wireless access points 102B-1, laptops 104E-1, and peripheral devices 104D-1, as well as other wired or wireless electronic devices. Similarly, user 104U2 may have one or more smartphones 104A-2, wireless access points 102B-2, laptops 104E-2, and peripheral devices 104D-2, as well as other wired or wireless electronic devices. Also, user 104UN may have one or more smartphones 104A-N, wireless access points 102B-N, laptops 104E-N, and peripheral devices 104D-N, as well as other wired or wireless electronic devices. In certain embodiments, one or more user devices 104UD may be connected to network 106 or wireless local area network 101B through a wired connection.

Moreover, by way of illustration only and not by way of limitation, wireless local area network area 101B may include one or more resource provider devices (hereinafter “104RD”). A resource provider may include, for example, an administrator, instructor, teacher, or the like, to at least, select, customize, or distribute data to wireless network area 101A. In some embodiments, resource provider devices 104D may include one or more computing devices, for example, one or more smartphones 104A, wireless access points 102A, laptops 104B, peripheral devices 104C and 104D, as well as other wired or wireless electronic devices. In many embodiments, the resource provider device 104RD may be similar to a user device that provides content, instruction, tasks, and other materials for user(s) within each wireless computing node 104LN.

In many embodiments, user device 104UD and resource provider device 104RD may include computing devices that represent various forms of processing devices. By way of example and without limitation, processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any of these data processing devices or other data processing devices. In one or more implementations, one or more user devices 104UD and resource provider devices 104RD may include one or more of active devices, passive devices and/or implemented wholly or partially as system on chip devices. In some embodiments, one or more user devices 104UD and one or more resource provider devices 104RD may include a transmitter, a receiver, a Global Positioning System (GPS), a Bluetooth (BT)/BLE transceiver and/or a WiFi™ transceiver.

Wireless local area networks 101A-101B may include, but not be limited to, a computer network that covers a limited geographic area (e.g., a home, school, computer laboratory, or office building) using a wireless distribution method (e.g., spread-spectrum or OFDM). In some embodiments, user devices 104UD and resource provider devices 104RD (i.e., wireless client devices) may associate with wireless access point 102B and 102A, respectively, to access network 106 using WiFi™ standards (e.g., IEEE 802.11). Wireless access points 102A, 102B may include other network components in addition to a wireless access point. For example, wireless access points 102A, 102B may include a router, switch, bridge, broadband modem etc. According to aspects of the subject technology, wireless access points 102A, 102B may be a wireless router that provides both access point functionality and network routing functionality.

As depicted in FIG. 1, one or more user devices 104UD may connect and communicate with its respective wireless access point 102B-1, 102B-2 . . . 102B-N using wireless links, and resource provider devices 104RD may connect and communicate with the wireless access point 102A using wireless links. These wireless links may be established and managed using various protocols including the IEEE 802.11 protocols. The user devices 104UD and resource provider devices 104RD may communicate wirelessly through a communication interface (not shown), which may include digital signal processing circuitry. In addition to the IEEE 802.11 protocols, the communication interface may provide for communications under other modes or protocols such as, for example. Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others.

Peripheral devices 104D-1, 104D-2 . . . 104D-N, 104C, and 104D represent devices that provide different functionality to users of the wireless local area network 101A and 101B, respectively. In certain embodiments, peripheral device 104C may be a printer or a multifunction machine that combines printing, scanning and fax functionality, for example. In some embodiments, peripheral devices 104C may be a monitor configured with additional hardware for receiving input, for example, one or more processors, memory units, touch input, storage devices, ethernet adapter, and other interfaces for input and output. In many embodiments, peripheral devices, for example peripheral device 104D-1 may communicate with the wireless access point 102B-1 via a wireless link or may communicate with the wireless access point 102B-1 via a wired connection.

Server 140 may be any system or device having a processor, a memory, and communications capability for providing content and/or services to the user devices 104UD and resource provider devices 104RD, for example. In some example aspects, the server 140 can include a single computing device 144, for example, or can include more than one computing device working together to perform the actions of a server (e.g., cloud computing, server farm, etc.,). Further, the server 140 can represent various forms of servers including, but not limited to, a web server, an application server, a proxy server, etc.

Similarly, server 160 may be any system or device having a processor, a memory, and communications capability for providing content and/or services to the user devices 104UD and resource provider devices 104RD. In some example aspects, the server 160 may be a single computing device 164, for example, or may include more than one computing device working together to perform the actions of a server (e.g., cloud computing, server farm, etc.,). Further, the server 160 may represent various forms of servers including, but not limited to, a web server, an application server, a proxy server, etc.

In some embodiments, a cloud-based service may be implemented that includes services provided by one or more servers, such as server 140 and server 160, via one or more networks, such as network 106. Cloud-based services may require authentication of user account credentials for access via a cloud-based application, such as a web-based personal portal, a web-based email application, etc. A cloud-based service has access to computer-readable storage devices 142 and 162 and may store information or data of a user once the user account credentials are authenticated. The stored data or information is also available to the user for future access and configuration via other applications that are employed by the user. A cloud-based service may include a social networking service. A social networking service may enable users to create a profile and associate with other users of the social networking service and allow users to share content and messages with other users of the social networking service. According to aspects of the subject technology, user devices 104UD may be associated to a user account in a cloud-based service provided by server 140, for example. Similarly, resource provider devices 104RD may be associated to an administrator account (e.g., instructor, professor, etc.,) in a cloud-based service provided by server 140, for example. The user account has a user profile associated to the user. The user profile may contain information and preferences related to wireless user computing devices within a wireless computing node 104LN of the wireless area local network 101A. The administrator account has a user profile associated to the administrator. The administrator profile may contain information and preferences related to one or more resource provider devices of the wireless area local network 101B.

It should also be appreciated that the server 140 and 160 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway or other computing device may comprise any combination of hardware or software that can interact and perform the described types of functionality, including without limitation: desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities.

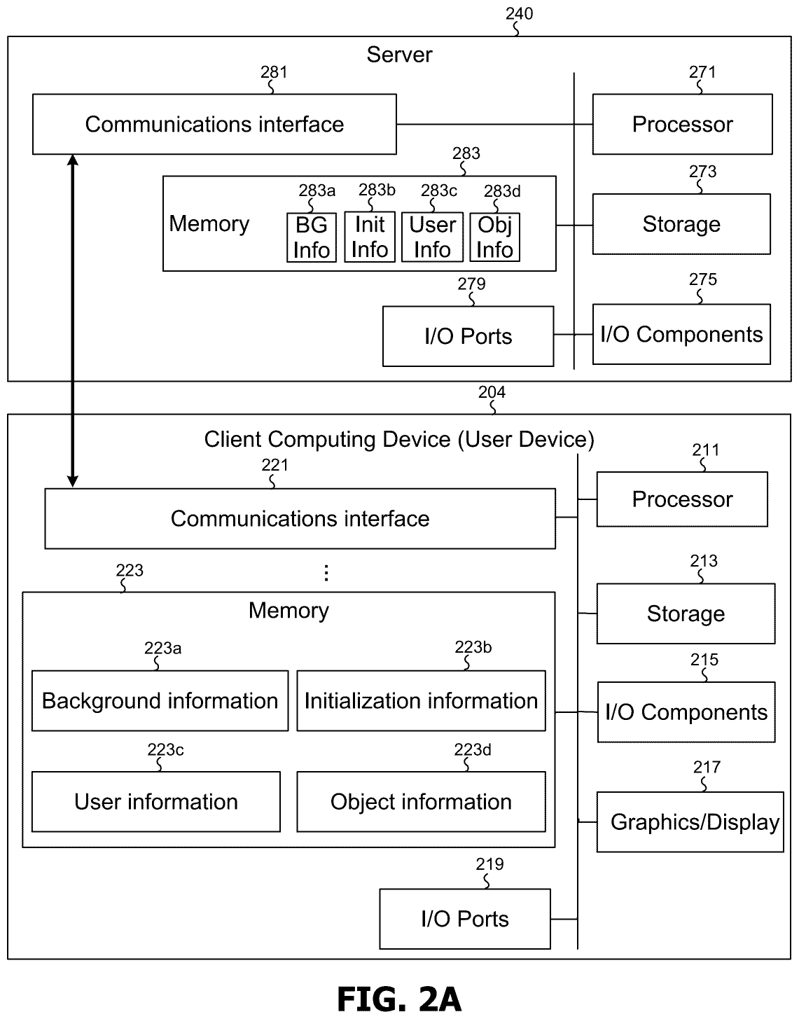

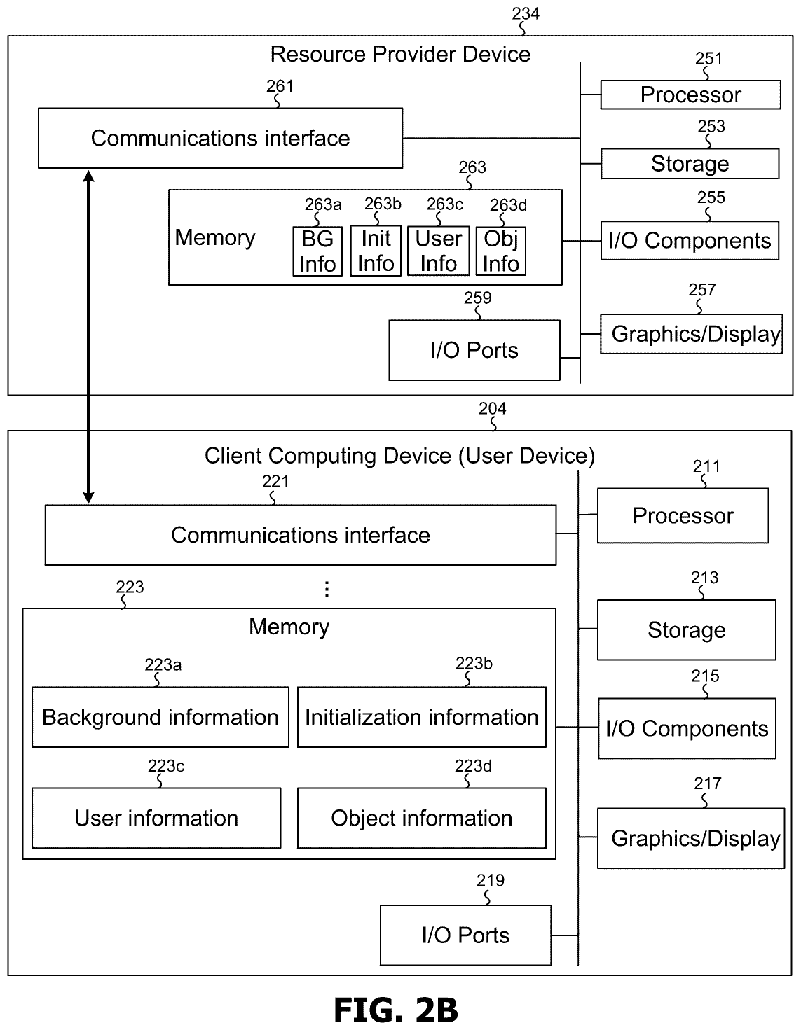

FIG. 2A illustrates a block diagram of an example client computing device and example server configured for the network environment of FIG. 1, according to some of the disclosed embodiments. As shown in FIGS. 2A-2B, the example client computing device 204 may be configured for implementing a server to client communication system for providing real-time interactive teaching and learning environments. The client computing device 204 may include one or more processors 211, storage 213, I/O components 215, graphics/display unit 217, input/output (I/O) ports 219, communications interface 221, and computer-storage memory (memory) 223. The client computing device 204 is able to communicate over a network 106 with other devices, such as the disclosed cloud-computing resources. Further, as shown in FIG. 2A, an example server 240 of servers 140 and/or 160, may be configured for implementing a server to client communication system for providing real-time interactive teaching and learning environments. The server 240 may include one or more processors 271, storage 273, I/O components 275, input/output (I/O) ports 279, communications interface 281, computer-storage memory (memory) 283. The server 240 may communicate over a network 106 with other devices, such as the client computing devices 204, other active servers 140, 160, resource provider device 104RD, or one or more user devices 104UD.

The client computing device 204 may be any of several types of computing device, such as, for example but without limitation, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, tablet, virtual reality (VR) or augmented reality (AR) headset, or the like. While the client computing device 204 is depicted as a single device, multiple client computing devices 204 as shown in FIG. 1 may work together and share the depicted device resources. For instance, various processors 211 and memory 223 may be housed and distributed across multiple client computing devices 204. The client computing device 204 may be one example of a suitable computing environment and is not intended to suggest any limitation as to the scope of use or functionality of the invention.

The processor 211 may include any number of microprocessors, microcontrollers, graphics processing units (GPUs), central processing units (CPUs), quantum processing units (QPUs), analog circuitry, or the like that may be programmed to execute computer-executable instructions for implementing aspects of this disclosure. In some embodiments, the processor 211 may be programmed to execute instructions such as those illustrated in the other drawings discussed herein. In certain embodiments, the processor 211 may be programmed with instructions to function for the specialized purpose of providing code (e.g., source code, block code, visual objects, etc.,), metadata, text, media, applications, and other programs and data that allows user(s) to enter a query, data, edit text or code, and run, interpret or compile the code, as well as access one or more applications to write, edit, run or debug code to be executed and then see resultant query results.

The processor 211 may include one or multiple processors and peripheral circuits thereof. The processor 211 may carry out the application, simulation, or game, and may perform processing for communicating user data associated with one or more client computing devices 204. The user data may comprise, for example, user status, progress, ranking, data, etc., of the client computing devices 204, game, simulation, or application progress and initialization information, as well as environmental information (e.g. terrain and object information) and other information for the and game, application, or simulation

The storage 213 may include at least one of a semiconductor memory, a magnetic disk device, and an optical disk device, or the like, for example. The storage 213 stores various applications, games, and user, application and/or game data to be sent to the server 140, 160. The storage 213 stores program, data, and/or instructions for processing client computing devices 204 requests and data (e.g., received from server 140, 160, or another client computing devices 204). Moreover, the storage 213 also stores the application, simulation, and game data, game or simulation initialization data, background data, user account information, user, game and simulation environmental information and/or in game or simulation object positioning data, etc. In addition, the storage 213 may also store temporary (e.g., preload or prefetch) data related to predetermined or anticipated processing, sequence, instruction, or task.

Further, the storage 213 may include any quantity of memory devices associated with or accessible by the client computing device 204. In certain embodiments, storage 213 may include any quantity of memory devices associated with or accessible by the client computing device 204. In some embodiments, storage 213 may take the form of the computer-storage media referenced below and operatively provides storage of computer-readable code, data structures, program modules, executable computer instructions for an operating system (OS), software applications, firmware, and other code for the client computing device 204 to store and access instructions configured to carry out the various operations disclosed herein. For example, storage 213 may include memory devices in the form of volatile and/or nonvolatile memory, removable or non-removable memory, data disks in virtual environments, or a combination thereof. Examples of storage 213 may include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other computer memory.

The graphics/display unit 217 may be any GPU or equivalent device capable of displaying content on a screen, for example, a liquid crystal display, an organic EL display, projectors, plasma tv, and the like. In some embodiments, the graphics/display unit 217 may be a dedicated or standalone GPU. In certain embodiments, the graphics/display unit 217 may integrate a display and GPU, for example, a dedicated GPU system and a display unit integrated within a standalone computer system.

The I/O ports 219 may connect various hardware I/O components 215 to the client computing device 204. Example I/O components 215 include, for example but without limitation, one or more microphones, cameras, and speakers that operate to capture and present audio/visual content. The client computing device 204 may additionally or alternatively be equipped with other hardware I/O components 215, such as, for example but without limitation, displays, touch screens, AR and VR headsets, peripheral devices, joysticks, scanner, printers, etc. Such components are well known to those in the art and need not be discussed at length herein.

The communications interface 221 allows software code, instructions, and data to be transferred between the client computer device 204 and external devices over the network 106. The communications interface 221 may include a modem, a network interface (such as an Ethernet card), a communications port, a Personal Computer Memory Card International Association (PCMCIA) slot and card, a wireless adapter, etc. Software code, instructions, and data transferred via the communications interface 221 are in the form of signals that may be electronic, electromagnetic, optical, or other signals capable of being received by communications interface 221. Such signals are provided to the communications interface 221 via the communications path (e.g., channel). The communications path carries the signals and may be implemented using a wired, wireless, fiber optic, telephone, cellular, radio frequency (RF), or other communications channel. In some embodiments, the communications interface 221 may be coupled to the processor 211 and/or integrated as a system-in-package or system-on-chip device and/or collectively defined as having a network interface and wired/wireless controller.

The memory 223 may store user, game or simulation data or records comprising of background information 223a including user, game, or simulation data, media, connection, configuration and profiles, initialization information 223b including game or simulation version information and map information (map version, topology, etc.) players, locations, status, and ranking, etc., user information 223c (e.g. profile, account, stats, rewards, rankings, etc.), and object information 223d including game or simulation positioning information and environmental information (e.g. object details, locations and distances). The memory 223 may store and process user data from all client computer devices 204 as received by client computer device 204 messages. In some embodiments, the server 240 may processes client computer device 204 messages, compile a message containing list of pertinent user data and communication to be broadcast to all client computer devices 204, then transmits the message to all client computer devices 204. The memory 223 may include memory devices in the form of volatile and/or nonvolatile memory, removable or non-removable memory, data disks in virtual environments, or a combination thereof.

Examples of memory 223 include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other computer memory. The memory 223 may include executable instructions, executable code instructions, or the like that cause the processor(s) 211 to be specifically programmed for building, analyzing, or otherwise executing the code, function, action, program, or task contained within executable instructions. The processor 211 may retrieve and execute instructions from memory 223, to perform the processes of the present disclosure. Memory 223 may provide a temporary location to store data and instructions retrieved and processed by processor 211.

As shown in FIG. 2A, the example server 240 may be configured to be part of a networking environment for operating a cloud service in a cloud environment that provides content, media, files, and data for implementing a server to client communication system for providing real-time interactive teaching and learning environments. As shown in FIG. 1, various user devices 104UD and resource provider devices 104RD may communicate over a network 106 with a collection of servers 140, 160 that make up the cloud environment. The servers 240 may include physical servers, virtual machines (VMs), or a combination thereof, and may include various dedicated, relational, virtual, private, public, hybrid, or other cloud-based resource. One skilled in the art will understand and appreciate that various server topologies may be used to construct the cloud environment.

In one instance, tangible hardware elements, or machines, are integral, or operably coupled, to the servers 240 to enable each device or VM to perform a variety of processes and operations. Specifically, the servers 240 include or have access to various processors 271, storage 273, I/O components 275, I/O ports 279, communications interfaces 281, and computer-storage memory 208. Though not shown, the processors 271 execute a server OS that underlies the execution of software, applications, and computer programs thereon. In particular, the processors 202 employed in the cloud-computing environment 200 may include real or virtual CPUs, GPUs, quantum processors, or the like. Although singular computing systems and components are show for clarity, a plurality of processors 271, storage 273, I/O components 275, I/O ports 279, communications interfaces 281, and computer-storage memory 208 may be used, located on and executed by different servers 240 and/or VMs.

The processor 271 may include any number of microprocessors, microcontrollers, graphics processing units (GPUs), central processing units (CPUs), quantum processing units (QPUs), analog circuitry, or the like that may be programmed to execute computer-executable instructions for implementing aspects of this disclosure. In some embodiments, the processor 271 may be programmed to execute instructions such as those illustrated in the other drawings discussed herein. In certain embodiments, the processor 271 may be programmed with instructions to function for the specialized purpose of providing to one or more client computing devices 204, code (e.g., source code, block code, visual objects, etc.,), metadata, text, media, applications, and other programs and data that allows user(s) to enter a query, data, edit text or code, and run, interpret or compile the code, as well as access one or more applications to write, edit, run or debug code to be executed and then see resultant query results. The processor 271 may carry out the application, simulation, or game, and may perform processing for communicating user data associated with one or more client computing devices 204 to the client computing devices 204 and other client computing devices 204. The user data may comprise, for example, user status, progress, ranking, data, etc., of the client computing devices 204, game, simulation, or application progress and initialization information, as well as environmental information (e.g. terrain and object information) and other information for the and game, application, or simulation.

The storage 273 may include at least one of a semiconductor memory, a magnetic disk device, and an optical disk device, or the like, for example. The storage 273 stores various applications, games, and user, application and/or game data to be sent to the client computing devices 204 and/or resource provider device 234. The storage 273 stores program, data, and/or instructions for processing client computing devices 204 and/or resource provider device 234 requests and data. Moreover, the storage 273 also stores the application, simulation, and game data, game or simulation initialization data, background data, user account information, user, game and simulation environmental information and/or in game or simulation object positioning data, etc. Furthermore, the storage 273 also stores one or more tables representing the association of the identification number (ID) of other players or client computing devices 204, other active servers 140, 160, and/or client computing devices 204, resource provider device 234, as well as additional or modified content for the game, simulation, and/or application from another server 140, 160, or resource provider device 104RD or another client computing devices 204. In addition, the storage 273 may also store temporary (e.g., preload or prefetch) data related to predetermined or anticipated processing, sequence, instruction, or task. In some embodiments, storage 273 may take the form of the computer-storage media referenced below and operatively provides storage of computer-readable code, data structures, program modules, executable computer instructions for an operating system (OS), software applications, firmware, and other code for the client computing device 204 and/or resource provider device 234 to store and access instructions configured to carry out the various operations disclosed herein.

The I/O ports 279 may connect various hardware I/O components 275 to the server 240. Example I/O components 275 include, for example but without limitation, one or more microphones, cameras, and speakers that operate to capture and present audio/visual content. The server 240 may additionally or alternatively be equipped with other hardware I/O components 275, such as, for example but without limitation, displays, touch screens, AR and VR headsets, peripheral devices, joysticks, scanner, printers, etc. Such components are well known to those in the art and need not be discussed at length herein.

The communications interface 221 allows software code, instructions, and data to be transferred between the client computer device 204, other active servers 140, 160, resource provider device 234, and external devices over the network 106. The communications interface 221 may include a modem, a network interface (such as an Ethernet card), a communications port, a wireless adapter, etc. Software code, instructions, and data transferred via the communications interface 221 are in the form of signals that may be electronic, electromagnetic, optical, or other signals capable of being received by communications interface 221. Such signals are provided to the communications interface 221 via the communications path (e.g., channel). The communications path carries the signals and may be implemented using a wired, wireless, fiber optic, telephone, cellular, radio frequency (RF), or other communications channel. In some embodiments, the communications interface 221 may be coupled to the processor 211 and/or integrated as a system-in-package or system-on-chip device and/or collectively defined as having a network interface and wired/wireless controller.

The memory 283 may store user, game or simulation data or records comprising of background information 283a including user, game, or simulation data, media, connection, configuration and profiles, initialization information 283b including game or simulation version information and map information (map version, topology, etc.) players, locations, status, and ranking, etc., user information 283c (e.g. profile, account, stats, rewards, rankings, etc.), and object information 283d including game or simulation positioning information and environmental information (e.g. object details, locations and distances). The memory 283 may store and process user data from all client computer devices 204 as received by client computer device 204, other active servers 140, 160, and resource provider device 234 communications. In some embodiments, the server 240 may processes client computer device 204 and resource provider device 234 messages, compile a message containing list of pertinent user data and communication to be broadcast to all client computer devices 204 and resource provider device 234, then transmits the message to all client computer devices 204 and resource provider device 234. The memory 283 may include memory devices in the form of volatile and/or nonvolatile memory, removable or non-removable memory, data disks in virtual environments, or a combination thereof.

Examples of memory 283 include, without limitation, random access memory (RAM); read only memory (ROM): electronically erasable programmable read only memory (EEPROM); flash memory or other memory technologies: CDROM, digital versatile disks (DVDs) or other optical or holographic media; magnetic cassettes, magnetic tape, magnetic disk storage or other magnetic storage devices; memory wired into an analog computing device; or any other computer memory. The memory 283 may include executable instructions, executable code instructions, or the like that cause the processor(s) 271 to be specifically programmed for building, analyzing, or otherwise executing the code, function, action, program, or task contained within executable instructions. The processor 271 may retrieve and execute instructions from memory 283, to perform the processes of the present disclosure. Memory 283 may provide a temporary location to store data and instructions retrieved and processed by processor 271.

While the server 240 is depicted as a single device, multiple servers 240 as shown in FIG. 1 may be used to work together and share the depicted server resources for implementing a server to client communication system for providing real-time interactive teaching and learning environments. For instance, various processors 271 and memory 283 may be housed and distributed across multiple servers 240.

FIG. 2B illustrates a block diagram of an example resource provider device and example client computing device configured for the network environment of FIG. 1, according to some of the disclosed embodiments. As shown in FIG. 2B, the example resource provider device 234 may be configured for providing real-time interactive teaching and learning environments. The resource provider device 234 may include one or more processors 251, storage 253, I/O components 255, graphics/display unit 257, input/output (I/O) ports 259, communications interface 261, and computer-storage memory (memory) 263. The resource provider device 234 may communicate through at least one of a direct connection with one or more client computing devices 204, and over a network 106 with other devices, such as one or more other client computing devices 204, other active servers 140, 160, other resource provider devices 104RD, or one or more user devices 104UD. As shown in FIG. 1, various user devices 104UD and resource provider devices 104RD may communicate over a network 106 with a collection of servers 140, 160 that make up the cloud environment. In some embodiments, resource provider devices 234 may include physical servers, virtual machines (VMs), or a combination thereof, and may include various dedicated, relational, virtual, private, public, hybrid, or other cloud-based resource. One skilled in the art will understand and appreciate that various server topologies may be used to construct the cloud environment. In certain embodiments, tangible hardware elements, or machines, are integral, or operably coupled, to the resource provider devices 234 to enable each device or VM to perform a variety of processes and operations as detailed above.

The processor 251 may include any number of microprocessors, microcontrollers, graphics processing units (GPUs), central processing units (CPUs), quantum processing units (QPUs), analog circuitry, or the like that may be programmed to execute computer-executable instructions for implementing aspects of this disclosure. In some embodiments, the processor 251 may be programmed to execute instructions such as those illustrated in the other drawings discussed herein. In certain embodiments, the processor 251 may be programmed with instructions to function for the specialized purpose of providing to one or more client computing devices 204, code (e.g., source code, block code, visual objects, etc.,), metadata, text, media, applications, and other programs and data that allows user(s) to enter a query, data, edit text or code, and run, interpret or compile the code, as well as access one or more applications to write, edit, run or debug code to be executed and then see resultant query results. The processor 251 may carry out the application, simulation, or game, and may perform processing for communicating user data associated with one or more client computing devices 204 to the client computing devices 204 and other client computing devices 204, resource provider devices 234, and one or more servers 140. The user data may comprise, for example, user status, progress, ranking, data, etc., of the client computing devices 234, game, simulation, or application progress and initialization information, as well as environmental information (e.g. terrain and object information) and other information for the and game, application, or simulation.

The storage 253 may include at least one of a semiconductor memory, a magnetic disk device, and an optical disk device, or the like, for example. The storage 253 stores various applications, games, and user, application and/or game data to be sent to the client computing devices 204 and/or resource provider device 234. The storage 253 stores program, data, and/or instructions for processing client computing devices 204 and/or resource provider device 234 requests and data. Moreover, the storage 253 also stores the application, simulation, and game data, game or simulation initialization data, background data, user account information, user, game and simulation environmental information and/or in game or simulation object positioning data, etc. Furthermore, the storage 253 also stores one or more tables representing the association of the identification number (ID) of other players or client computing devices 204, other active servers 140, 160, and/or client computing devices 204, resource provider device 234, as well as additional or modified content for the game, simulation, and/or application from another server 140, 160, or resource provider device 104RD or another client computing devices 204. In addition, the storage 253 may also store temporary (e.g., preload or prefetch) data related to predetermined or anticipated processing, sequence, instruction, or task. In some embodiments, storage 253 may take the form of the computer-storage media referenced below and operatively provides storage of computer-readable code, data structures, program modules, executable computer instructions for an operating system (OS), software applications, firmware, and other code for the client computing device 204 and/or resource provider device 234 to store and access instructions configured to carry out the various operations disclosed herein.

The graphics/display unit 257 may be any GPU or equivalent device capable of displaying content on a screen, for example, a liquid crystal display, an organic EL display, projectors, plasma tv, and the like. In some embodiments, the graphics/display unit 257 may be a dedicated or standalone GPU. In certain embodiments, the graphics/display unit 257 may integrate a display and GPU, for example, a dedicated GPU system and a display unit integrated within a standalone computer system.

The I/O ports 259 may connect various hardware I/O components 255 to the resource provider device 234. Example I/O components 255 include, for example but without limitation, one or more microphones, cameras, and speakers that operate to capture and present audio/visual content. The resource provider device 234 may additionally or alternatively be equipped with other hardware I/O components 255, such as, for example but without limitation, displays, touch screens, AR and VR headsets, peripheral devices, joysticks, scanner, printers, etc. Such components are well known to those in the art and need not be discussed at length herein.

The communications interface 261 may be configured to allow software code, instructions, and data to be transferred between one or more resource provider devices 234, client computer devices 204, active servers 140, 160, and external devices over the network 106. The communications interface 261 may include a modem, a network interface (such as an Ethernet card), a communications port, a wireless adapter, etc. Software code, instructions, and data transferred via the communications interface 261 are in the form of signals that may be electronic, electromagnetic, optical, or other signals capable of being received by communications interface 261. Such signals are provided to the communications interface 261 via the communications path (e.g., channel). The communications path carries the signals and may be implemented using a wired, wireless, fiber optic, telephone, cellular, radio frequency (RF), or other communications channel. In some embodiments, the communications interface 261 may be coupled to the processor 251 and/or integrated as a system-in-package or system-on-chip device and/or collectively defined as having a network interface and wired/wireless controller. While the resource provider device 234 is depicted as a single device, multiple resource provider devices 234 may be used to work together and share the depicted resources for implementing a real-time interactive teaching and learning environment.

The memory 263 may store user, game or simulation data or records comprising of background information 263a including user, game, or simulation data, media, connection, configuration and profiles, initialization information 263b including game or simulation version information and map information (map version, topology, etc.) players, locations, status, and ranking, etc., user information 263c (e.g. profile, account, stats, rewards, rankings, etc.), and object information 263d including game or simulation positioning information and environmental information (e.g. object details, locations and distances). The memory 263 may store and process user data from all client computer devices 204 as received by client computer device 204, other active servers 140, 160, and other resource provider device 234 communications. In some embodiments, the resource provider device 234 may processes client computer device 204 and other resource provider device 234 messages, compile a message containing list of pertinent user data and communication to be broadcast to all client computer devices 204 and other resource provider device 234, then transmits the message to all client computer devices 204 and other resource provider device 234. The memory 263 may include memory devices in the form of volatile and/or nonvolatile memory, removable or non-removable memory, data disks in virtual environments, or a combination thereof.

Examples of memory 263 include, without limitation, random access memory (RAM): read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other computer memory. The memory 263 may include executable instructions, executable code instructions, or the like that cause the processor(s) 251 to be specifically programmed for building, analyzing, or otherwise executing the code, function, action, program, or task contained within executable instructions. The processor 251 may retrieve and execute instructions from memory 263, to perform the processes of the present disclosure. Memory 263 may provide a temporary location to store data and instructions retrieved and processed by processor 251.

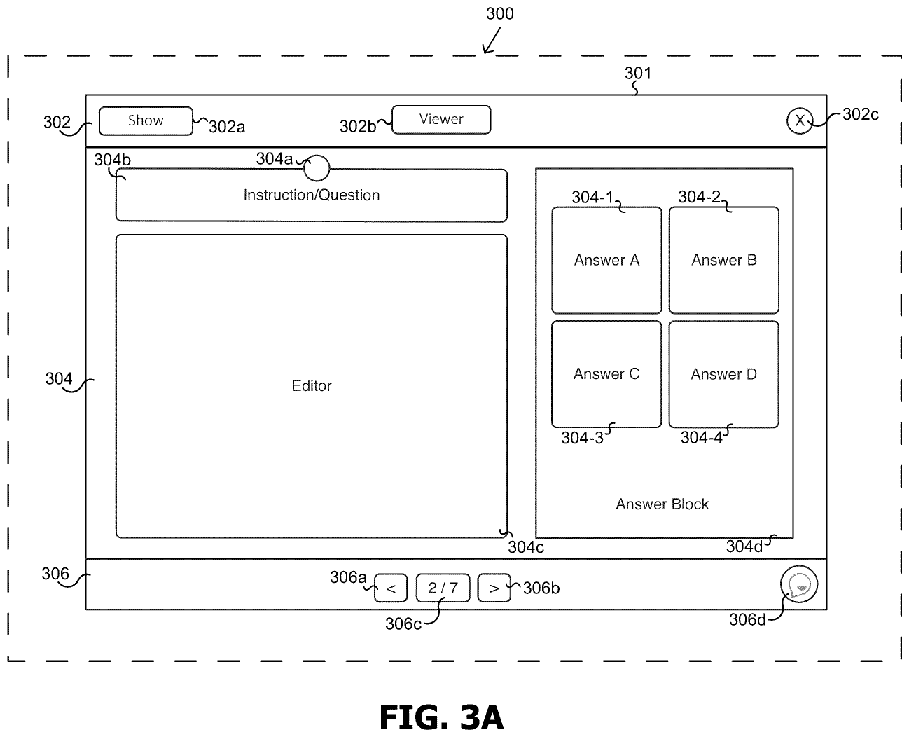

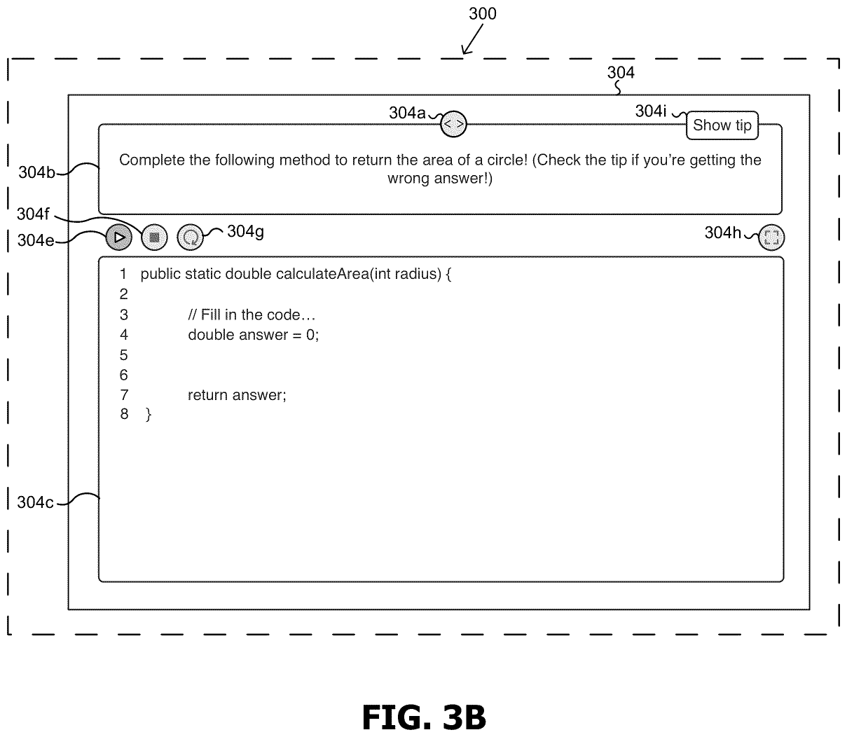

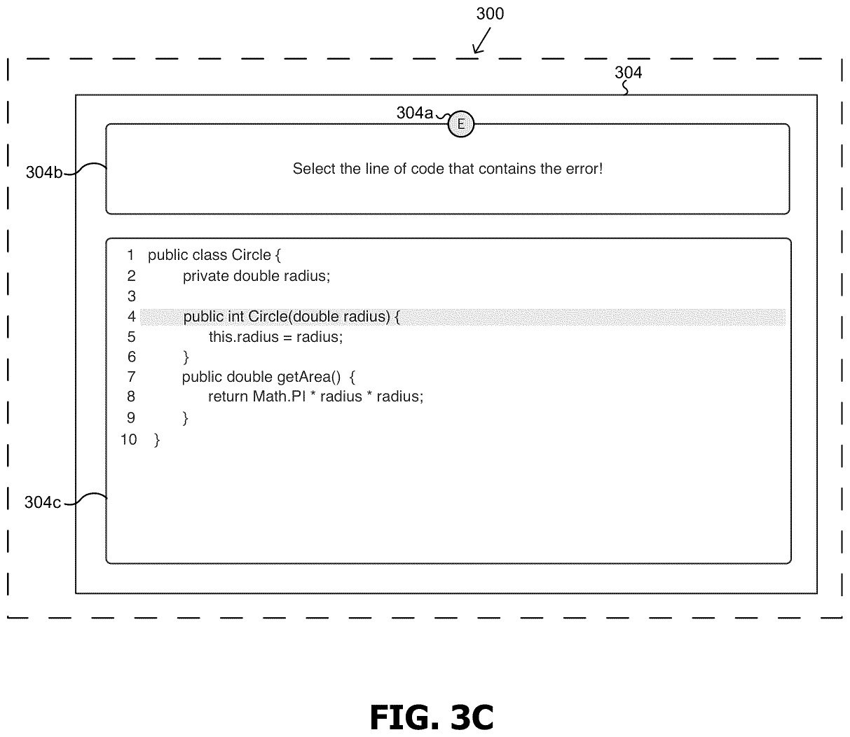

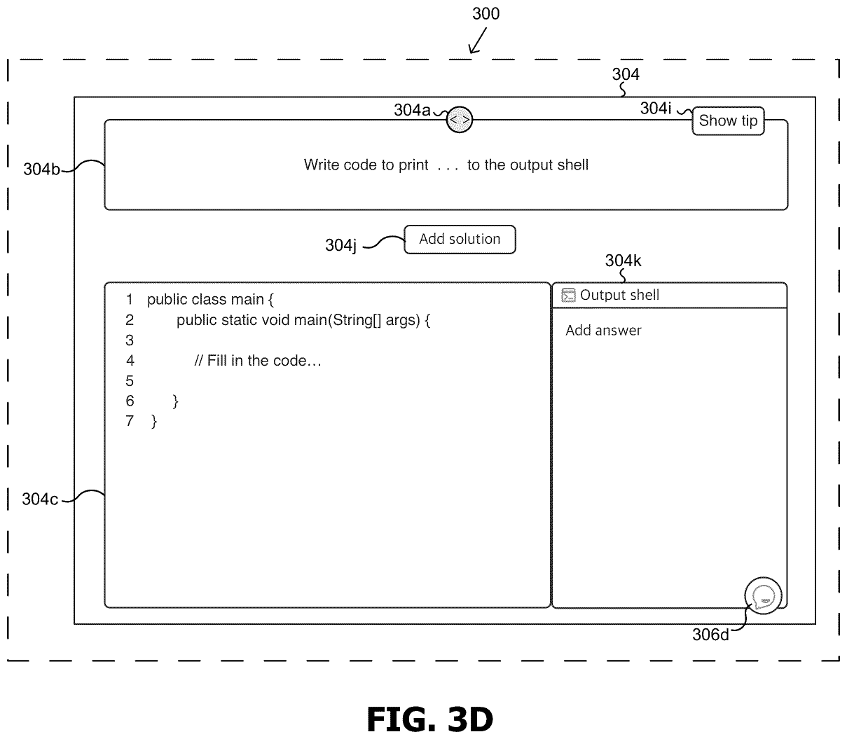

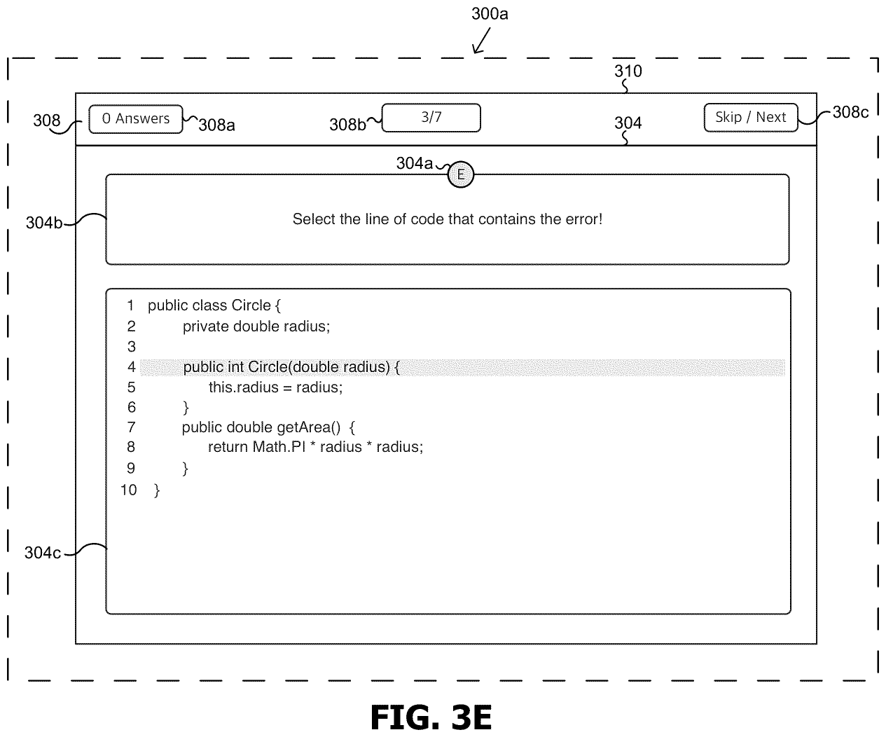

FIG. 3A illustrates a block diagram of an example graphical user interface for a learner in a real-time interactive teaching and learning environment, according to some of the disclosed embodiments. As shown in FIG. 3A, an example graphical user interface for a learner (e.g., client computer device 204) may be displayed on a display 300 and configured to a user interface 301 during a user session. The user session may include multiple or many users who participate in a real-time, interactive session. The server 140, 160 or resource provider device 104RD may provide each client computer device 204 with a plurality of content including questions, instructions, text, code, media, or other materials that is distributed in real-time and concurrently to every user during the user session. The session may include a game-like interactive quiz, test, simulation, game, or other challenge or multi-user competitive activity. The user interface 301 may be displayed on at least one of the client computer device 204 and the resource provider device 234. The user interface 301 may display one or more navigation fields 302, content fields 304, or interactive fields 306.

In some embodiments, an upper portion of the user interface 301 may include one or more navigation fields 302 having, for example, one or more actionable items 302a, 302c and one or more static or modifiable text fields displayed by a viewer 302b. The actionable item 302a may provide a solution, tips, hints, or additional or relevant material for the user. The actionable item 302c may be configured to close, minimize, or pause the user session. In some embodiments, the actionable item 302c may be greyed out, inaccessible, or not present to indicate the user session may not be paused or altered. In some embodiments, the viewer 302b may be a static text indicating the viewer is a student, in such case, the viewer 302b may include the name of the student, or the name of the quiz, question, coursework, class, subject matter, topic or content that is displayed in the user interface 301 for the student. In certain embodiments, the navigation field 302 may be configured for test preparation or test taking, where the viewer 302b may be inaccessible or not present, and actionable item 302a may provide a reference guide, hint, or access to written material or media pertaining to the question or instruction. In many embodiments, the user interface 301 may be configured to display content to various audiences and subject matter, for example, the viewer 302b may include display the subject for a test taker, a teacher, or the like.

In some embodiments, the body of the user interface 301 may include one or more content fields 304 having, for example, one or more question type indicators 304a, an instruction or question field 304b, an editor 304c, and an answer block 304d with a plurality of possible answers 304-1, 304-2, 304-3, 304-4 . . . 304-N (hereinafter “304-X”). The one or more question type indicators 304a may include text, image or graphic to readily indicate to the user the type of question or instruction that follows in instruction or question field 304b. The instruction or question field 304b may include one or more questions, examples, activities, instructions, tips, text, code, or metadata, or other information that the user may utilize to interact with the editor 304c and/or determine the best answer 304-X in answer block 304d. The contents of editor 304c may include text, code, metadata, comments, and the like. Moreover, in many embodiments, the editor 304c may include visual cues to assist in editing the contents of the editor 304c. In certain embodiments, the editor 304c may indicate lines numbers, provide auto completion, syntax highlighting, error detection (in the code, syntax, function, use, style, etc.,), and the like. In many embodiments, the editor 304c may further include and integrate an Integrated Development Environment (IDE) that may be used to write the code, detect errors, provide suggestions, phrases or text to auto complete inputted code.

Moreover, the editor 304c may include an IDE configured to run, interpret, or execute code. In certain embodiments, the IDE may determine the coding language entered and determine the proper means to compile, interpret, build, and run the code. Further the IDE, may be configured to determine the coding language entered, and determine the proper syntax, highlighting, error detection, auto completion, etc., to use for the inputted coding language. In certain embodiments, the IDE may be configured to include an output shell (see FIG. 7 and FIGS. 9-11) that displays the output of the interpreted code, executed code, or program that the user has written with code. In some embodiments, the IDE may be configured to include coding result feedback, when no specific output to the output shell has been made, to display the result of the code to the user. For example, if the user is writing a function, an IDE might display the value returned even when nothing has printed to the output shell directly. Whether the language is a compiled language, interpreted language, or any other kind of coding language, the user can run the code within the IDE, and if there is an error in the code, the user will be alerted.

In some embodiments, a lower portion of the user interface 301 may include one or more interactive fields 306 having, for example, one or more session action items 306a, 306b, a session indicator 306c, and a chat bubble 306d. The session action items 306a, 306b may be used to cycle through a plurality of questions or instructions provided during the user session. In some embodiments, the user may return to a previous question or move to the next question. In certain embodiments, the session action items 306a. 306b may be greyed out or inaccessible to the user during the user session. The session indicator 306c may be configured to be an actionable item that when pressed or activated displays a list of answered or attempted questions, topics, or a map or listing of all questions and/or remaining questions in the user session. The chat bubble 306d when pressed or activated may connect the user to an automated assistant or guide, or a live instructor or professional to provide help, feedback, or other assistance during the user session.

Many types of interactive games, activities, tests/quizzes, and simulations may be contemplated, as an example, and not intended to be limiting, a game-like interactive quiz having multiple users in a test, quiz, or competitive game or activity. In some embodiments, the activity may be configured to be on-your-own-time quiz, simulation, or game where users can answer the questions complete challenges or puzzles on their own time, but able to see other participant's past answers or scores. Moreover, the interactive game, activity, test/quiz, and simulation may involve real-time, simultaneous participation of multiple users with live questions and answers being displayed during the user session. Further, multiple users compete to either answer the questions the fastest or to get the most answers correct. In many embodiments, the interactive games, activities, tests/quizzes, and simulations may be accessible through a website or local network.

In some embodiments, a plurality of content is distributed to, and displayed on, each of one or more client computing devices 204. For example, a first content of a plurality of distributed content may be provide the text or question/instruction for a first question in the user session. A second content of the plurality of distributed content may be provide the initial or sample code for the user to configure, edit or run to obtain an answer. A third content of the plurality of distributed content may be provide the graphical user interface (GUI) for displaying the content on a user display 300. A fourth content of the plurality of distributed content may be provide the editor and access to IDE for running, executing, or interpreting the code. A fifth content of the plurality of distributed content may be provide multiple choice answers or options for the displayed question/instruction in the user session(s). A sixth content of the plurality of distributed content may provide debug and an output shell access for each of one or more client computing devices 204 for the question/instruction in the user session(s). A seventh content of the plurality of distributed content may provide one or more visual objects that encapsulate code. An eight content of the plurality of distributed content may provide access to a file manager, cloud storage, or other file and/or web browsing options to add, append, or provide code, text, or other data, media, or images for responding to the question/instruction.

FIG. 3B illustrates a block diagram of an example graphical user interface for a learner in a real-time interactive teaching and learning environment, according to some of the disclosed embodiments. As shown in FIG. 3B, an example graphical user interface for a learner (e.g., client computer device 204) may be displayed on a display 300 and configured to include a user interface 301 body that includes one or more content fields 304 having, for example, one or more question type indicators 304a, an instruction or question field 304b, tip action item 304i, an editor 304c configured to include an interpreter 304e, a halt process 304f, a rerun action item 304g, and full screen item 304h. In some embodiments, interpreter 304e may function as a compiler to runs code within editor 304c to build a program, application, etc. The halt process 304f may be configured to halt execution or running of the code, for example, it the code creates an infinite loop, has bug, or fails to execute within a certain time period. The rerun action item 304g may be used to rerun the code or edits to the code within editor 304c. The full screen item 304h may extend the editor 304c to cover the display in a full screen mode to allow a user to focus on code within the editor 304c. The tip action item 304i may provide user with relevant tips, materials, references, or media to assist in answering the question or instruction within the instruction or question field 304b.

In this example, the question requires the user of a client computing device 204 to add or append code within editor 304c with additional code, data, or information to answer the question. In some embodiments, the question to be answered in the instruction or question field 304b is time dependent and may require a prompt response. The code executed, interpreted, or run in the editor 304c is performed in real-time allow users to obtain a result feedback promptly, which can be very helpful for the user in determining the appropriate response to the question. Moreover, the ability to test the code and other variations of code in real-time facilitates improved comprehension and opens users to more creative responses or experimentation with the code inputted in editor 304c. In certain embodiments, the question to be answered in the instruction or question field 304b is not time dependent and the user may answer the question on their own time and see other answers that may be recorded or stored by a user of a resource provider device 234, or a selection of answers stored on one or more servers 240.

FIG. 3C illustrates a block diagram of an example graphical user interface for a learner in a real-time interactive teaching and learning environment, according to some of the disclosed embodiments. As shown in FIG. 3C, an example graphical user interface for a learner (e.g., client computer device 204) may be displayed on a display 300 and configured to include a user interface 301 body that includes one or more content fields 304 having, for example, one or more question type indicators 304a, an instruction or question field 304b, and an editor 304c.

In this example, the question requires the user of a client computing device 204 to select the line of code within editor 304c that contains an error to answer the question. In some embodiments, the question to be answered in the instruction or question field 304b is time dependent and may require a prompt response. In certain embodiments, the question to be answered in the instruction or question field 304b is not time dependent and the user may answer the question on their own time and see other answers that may be recorded or stored by a user of a resource provider device 234, or a selection of answers stored on one or more servers 240.

FIG. 3D illustrates a block diagram of an example graphical user interface for a learner in a real-time interactive teaching and learning environment, according to some of the disclosed embodiments. As shown in FIG. 3D, an example graphical user interface for a learner (e.g., client computer device 204) may be displayed on a display 300 and configured to include a user interface 301 body that includes one or more content fields 304 having, for example, one or more question type indicators 304a, an instruction or question field 304b, an editor 304c, a tip action item 304i, solution action item 304j, an output shell 304k, and a chat bubble 306d provided within the content field 304 of the user interface 301.

In this example, the question requires the user of a client computing device 204 to write code or provide a document or text that contains the solution to the instruction or question field 304b. In some embodiments, the document or text may be provided by a user of a client computing device 204 by pressing on or activating the solution action item 304j to allow a user to attach and send the text or document file for parsing and/or processing by the server 140, 160 or by a user of the resource provider device 234. In some embodiments, the question to be answered in the instruction or question field 304b is time dependent and may require a prompt response. In certain embodiments, the question to be answered in the instruction or question field 304b is not time dependent and the user may answer the question on their own time and see other answers that may be recorded or stored by a user of a resource provider device 234, or a selection of answers stored on one or more servers 240. The content field 304 may be further configured to include an output shell 304k that provides real-time result feedback and output from interpreting, running or compiling the code within editor 304c.

FIG. 3E illustrates a block diagram of an example graphical user interface for a resource provider in a real-time interactive teaching and learning environment, according to some of the disclosed embodiments. As shown in FIG. 3E, an example graphical user interface for a resource provider (e.g., resource provider device 234) may include a display 300a configured to display a body of the user interface 301 (the same interface seen by client computer device 204) that includes one or more content fields 304 having, for example, one or more question type indicators 304a, an instruction or question field 304b, and an editor 304c. In some embodiments, the resource provider (e.g., an instructor, professor, tutor, etc.,) display 300a includes the user interface 301 having an upper portion that may include one or more navigation fields 308. In many embodiments, the one or more navigation fields 308 includes, for example, at least one answer viewer 308a, a session indicator 308b, and a question toggle box 308c.

In many embodiments, the answer viewer 308a displaying the number of users having correctly answered the current displayed question in real-time. In some embodiments, answer viewer 308a can be an actionable item that when pressed or activated lists, for example, the users who have and have not answered the current displayed question, and the users who correctly and incorrectly answered the question. s correct one or more static or modifiable text fields displayed by a viewer 302b. The session indicator 308b may indicate the current and total number of questions for the user session. The question toggle box 308c may allow the resource provider to skip to the next question or progress to the next question once time has completed and/or once all users have provided an answer to the currently displayed question. In many embodiments, the resource provider may construct, preview, and start a quiz, test, or instruction session with multiple users in the real-time interactive teaching and learning environment. Further, the resource provider may view answers or end the quiz, test, or instruction session with multiple users at any time. In many embodiments, the user of the resource provider device 234 may access various pre-made quizzes and topics, either made by one or more resource providers or stored on one or more servers 140, 160.

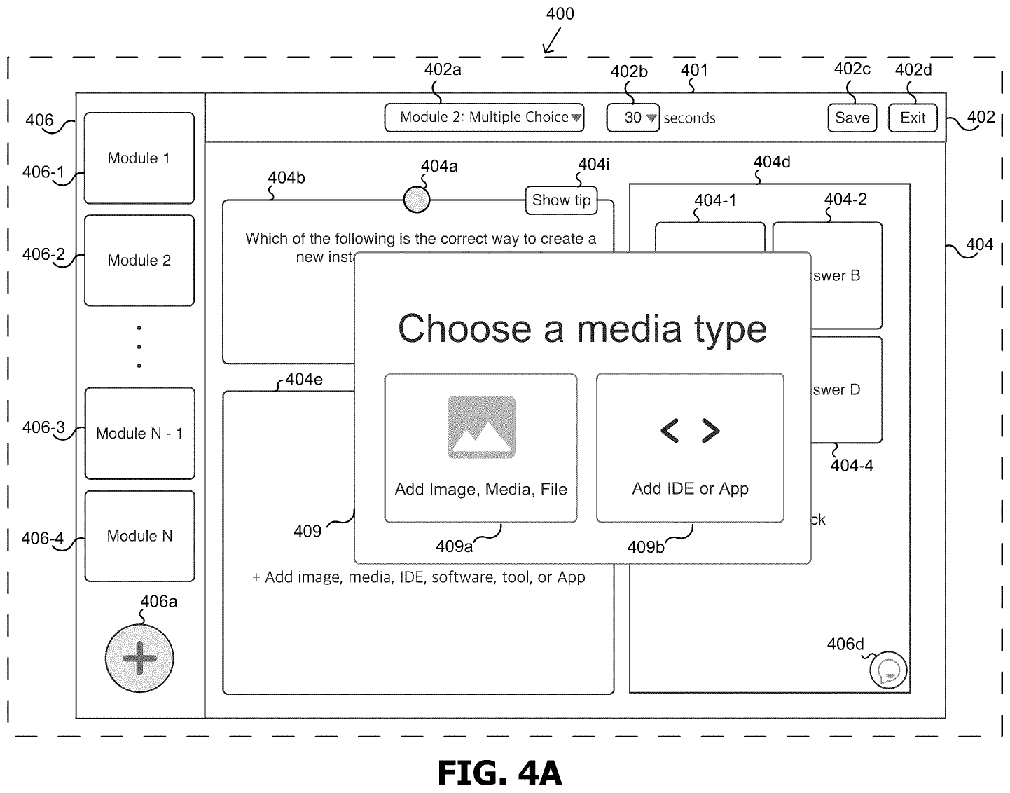

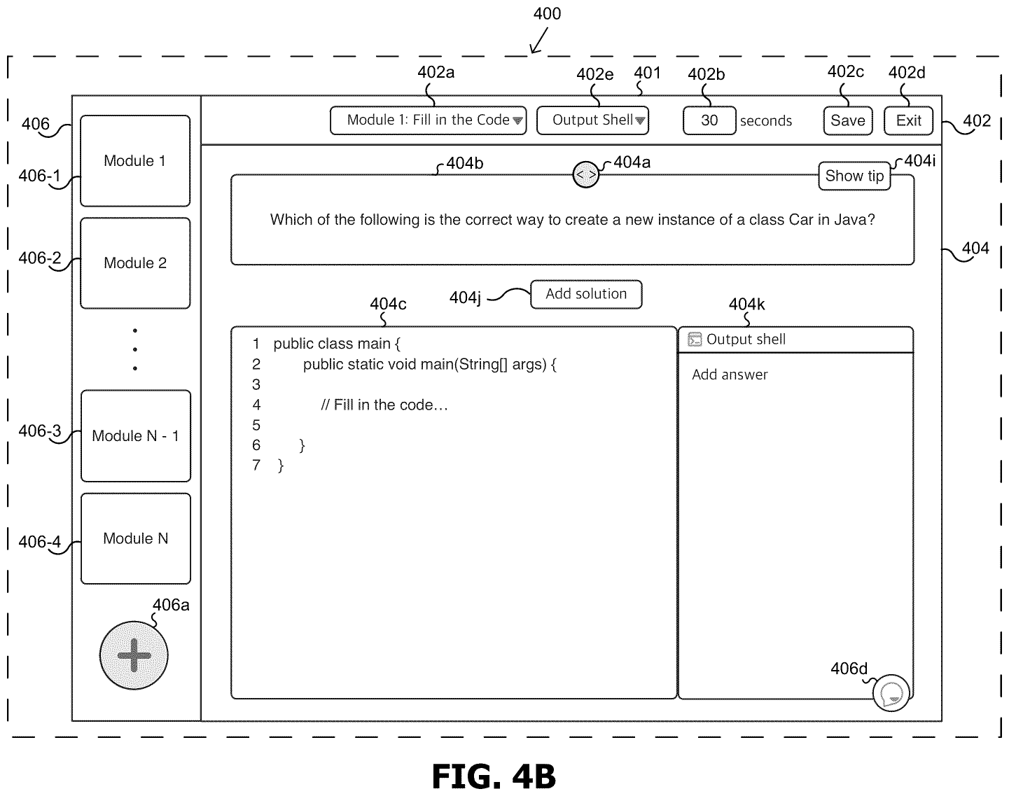

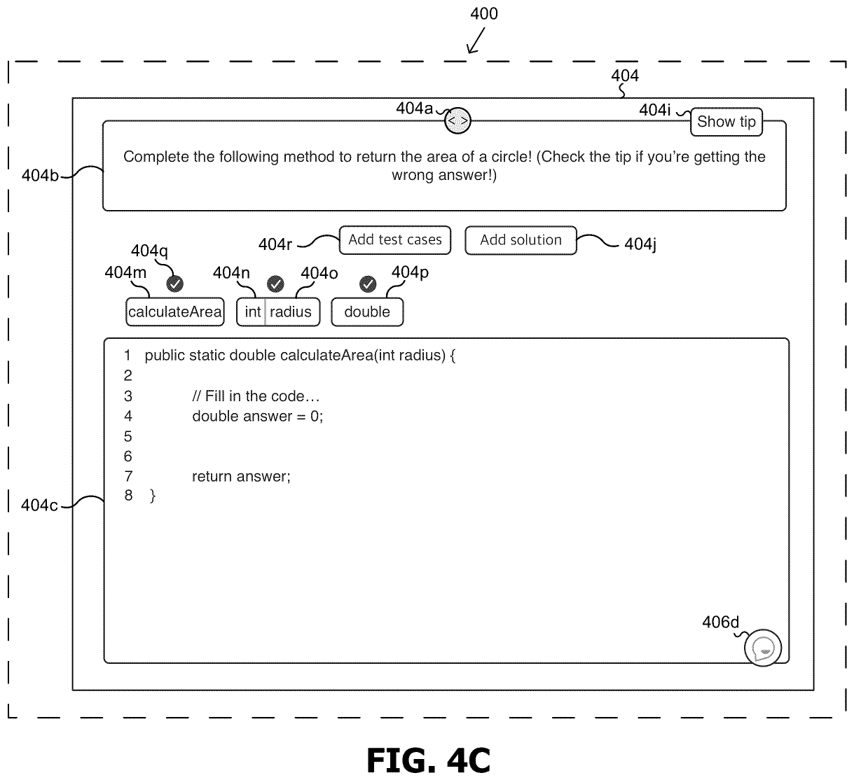

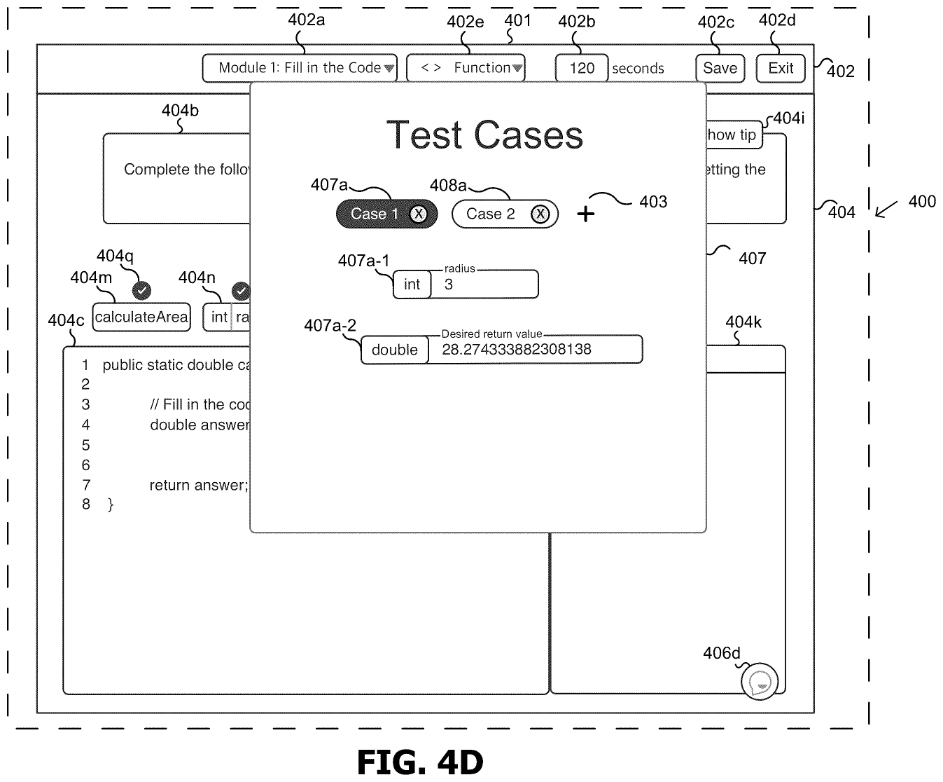

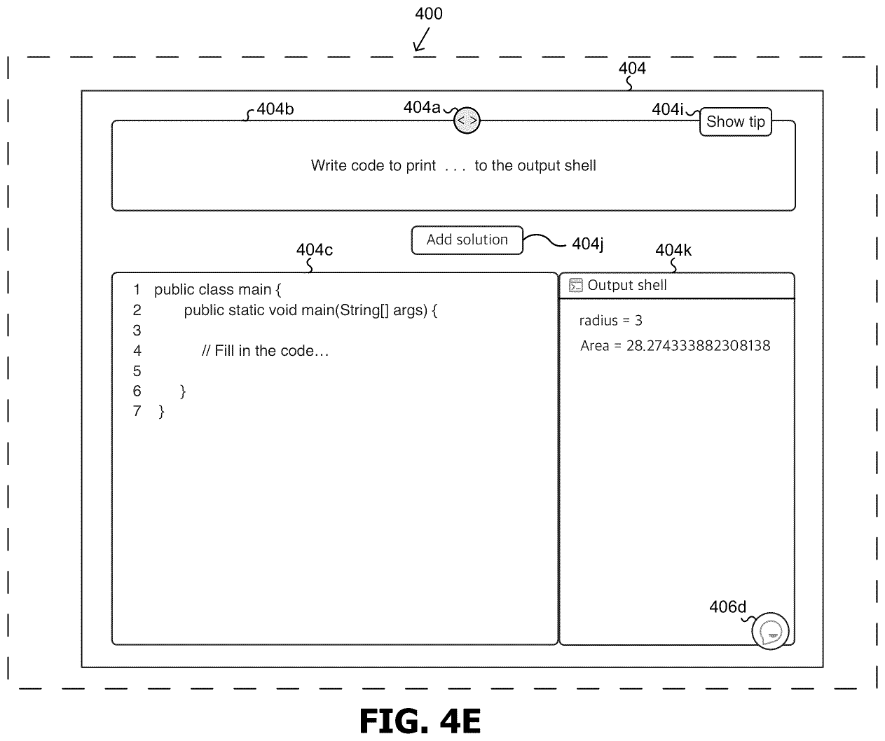

FIG. 4A illustrates a block diagram of an example user interface for a resource provider to create content for a real-time interactive teaching and learning environment, according to some of the disclosed embodiments. As shown in FIGS. 4A-4E, an example graphical user interface for a resource provider (e.g., a question or lesson module customization interface for a resource provider device 234) for creating, for example, content to be distributed in a real-time multi-user interactive teaching and learning environment may be displayed on a display 400 and configured to include a user interface 401 during a resource provider session. The resource provider device 234 may be used to create user sessions for multiple or many users who participate in a real-time, interactive session. The server 140, 160 or resource provider device 104RD may provide each client computer device 204 with a plurality of content including questions, instructions, text, code, media, or other materials that is distributed in real-time and concurrently to every user during the user session. Each learning or lesson module or screen may be created using the resource provider device 234 and a user session may be configured by the resource provider device 234 to include any or all learning or lesson modules. The user session created may include a game-like interactive quiz, test, simulation, game, or other challenge or multi-user competitive activity. The example user interface 401 may be configured to include one or more navigation fields 402, content fields 404.

As shown in the example FIG. 4A, the content field 404 includes a “multiple choice” module 406-1 and course module fields 406. The user interface 401 may include a plurality of modules 406-1, 406-2, 406-3, 406-4 . . . 406-N (hereinafter “406-X”), each module may pertain to a different question type, course, class, subject matter, goal, or objective. In some embodiments, as an example, module 406-1 may include a “multiple choice” question type, module 406-2 may include a “fill in the code” question type, module 406-3 may include a “spot the error” question type, and module 406-4 may include a “what is the output” question type. Many other types of questions and variations may be contemplated, and the examples described in these embodiments should be seen as limitation on the question type, layout, or subject matter. For example, a question type may pertain to “investigate/optimize” climate conditions as a factor for oil exploration or seismic activity, and the modules 406-X may include preloaded or predefined applications that provide analysis of relevant variables and environmental conditions to obtain an answer.

In some embodiments, an upper portion of the user interface 401 may include one or more navigation fields 402 having, for example, module field 402a, objective field 402b for completing the module, and one or more actionable items 402c (e.g., saving current state of module) and 402d (e.g., exiting module configuration). The example module field 402a may be a static or modifiable text field to name the module, question type, course, class, or subject and associate the module or lesson with an objective or goal. For example, the module field 402a may describe the subject matter as a “design simulation” or “material selection in road design” and the question type as a “multiple choice” type. The example objective field 402b may be a prefilled number based on the module 406-1 or a modifiable field/number to allow the resource provider to enter the amount of time for the selected module 406-X. In some embodiments, the objective field 402b may be used to determine the minimum number of selections, code, or input needed to qualify the answer as being sufficient to move on to the next question. For example, there may be a “fill in the fields” type question where multiple inputs are required for the question to be marked as attempted or answered to allow the user to progress to the next question. In certain embodiments, a background service or other script or program may be implemented to monitor multiple fields for input for the question, such that, when a sufficient number of fields or input is provided the service or script marks the question as being attempted or answered and the user is allowed to progress to the next question. The one or more actionable items 402c, 402d may allow the resource service provider to save the customized module and exit the customization interface.

In some embodiments, the body of the user interface 401 may include one or more content fields 404 having, for example, one or more question type indicators 404a, an instruction or question field 404b, a selectable tool field 404c, and an answer block 404d with a plurality of possible answers 404-1, 404-2 . . . 404-4 . . . 404-N (hereinafter “404-X”), a tip action item 404i, and a chat bubble 406d provided within the content field 404 of the user interface 401. The resource provider may select a module 406-X, the content of which may be displayed, in part or in whole, in one or more content fields 404. In some embodiments, the content field 404 of the selected module 406-X may include a template or include pre-filled data based on the subject matter and question type. In one embodiment, for example, a multiple choice module for a coding exercise may include a pre-customized layout with a plurality of fields and blocks as described above, including one or more question type indicators 404a, an instruction or question field 404b, a selectable tool field 404c, and an answer block 404d with a plurality of possible answers 404-X, a tip action item 404i, and a chat bubble 406d provided within the content field 404 of the user interface 401. The resource provider may provide data and information for filling out the instruction or question in instruction or question field 404b and may provide or not provide a tip action item 404i. Similarly, the resource provider may specify data and information for each answer 404-X in the answer block 404d, where, for example, the input may be text, code, image or media related to the subject matter and question type.

In many embodiments, the selectable tool field 404c may include various inputs, tools, and applications that may be specific to an environment in which the subject matter of the question may be tested, revised, and answered. For example, a resource provider may enter a question related to illustration in instruction or question field 404b and add, using selectable tool field 404c, an image and a software, for example an image editing software, where during the user session the user will see the image and have access to open the image editing software to edit the image. In some embodiments, the image editing software will be preloaded with the image once executed. In certain embodiments, the image editing software will have access to one or more folders, storage devices, web access, or cloud storage to access the image, files, or other media. In some embodiments, the software, app or tool may be embedded in the selectable tool field 404c and prefilled with the question or test data, as described above in FIG. 3B. In certain embodiments, the question data (e.g., code, image, etc.,) and software, app, or tool may be stored local or remotely accessible, in such cases, the resource provider may define the selectable tool field 404c as having multiple columns, one or more columns as buttons for the user to access or load the question data, and one or more columns as buttons for the user to access or load the software, app, or tool to test the question data and arrive at an answer.

In many embodiments, the tool window 409 may include one or more buttons to add one or more content 409a such as media, images, documents, and the like to one or more content fields 404 or into the selectable tool field 404c. In some embodiments, the tool window 409 embeds each content 409a directly into one or more content fields 404 or the selectable tool field 404c. Moreover, the layout of content fields 404 may dynamically adjust to accommodate each content 409a such as multiple media files, images, and documents. Further, content 409a may be stored local or remotely accessible in one or more folders, storage devices, websites, or cloud storage, or any combination thereof.

In many embodiments, the tool window 409 may include one or more buttons to add one or more applications 409b such as software, programs, apps, and other tools, and the like to one or more content fields 404 or into the selectable tool field 404c. In some embodiments, the tool window 409 embeds each application 409b directly into one or more content fields 404 or the selectable tool field 404c. Moreover, the layout of content fields 404 may dynamically adjust to accommodate each application 409b such as multiple software programs, apps, and other tools. Further, applications 409b may be stored local or remotely accessible in one or more folders, storage devices, websites, or cloud storage, or any combination thereof.

In some embodiments, an edge of the user interface 401 may include one or more course module fields 406 having, for example, one or more course modules 406-1, where each course module 406-1 may include one or more question types (e.g., multiple choice, fill in the blank, spot the error, etc.,), exercises (e.g., add code, optimize existing code, etc.,), course subjects (e.g., sort, arrange, or select objects to perform an action, operation, or complete the exercise, etc.,), or any combination thereof. In certain embodiments, other types of challenges or minigames may be included within the template or content of one or more course modules 406-1. For example, a fill in the blank question type once completed may be followed with an exercise to optimize the completed code. Each module 406-1 may include a template or pre-filled data based on the subject matter, exercise, course subject, and question type. The content for each module 406-1 may be premade, provide by one or more servers 104, 106, or custom built and edited by one or more resource provider devices 234, or any combination thereof. In some embodiments, a custom module may be added using a module editor 406a. Further, the module fields 406 may include one or more module editors 406a configured to allow users to add and define a different user interface 401 or select from existing user interfaces 401 and modify their content.

FIG. 4B illustrates a block diagram of an example user interface for a resource provider to create content for a real-time interactive teaching and learning environment, according to some of the disclosed embodiments. As shown in FIG. 4B, an example graphical user interface for a resource provider (e.g., a question or lesson module customization interface for a resource provider device 234) for creating, for example, content to be distributed in a real-time multi-user interactive teaching and learning environment may be displayed on a display 400 and configured to include a user interface 401 during a resource provider session. The example user interface 401 may be configured to include one or more navigation fields 402, content fields 404 (as shown in this example the contents of a “fill in the code” module 406-3), and course module fields 406.

The user interface 401 may include an embedded editor 404c and output shell 404k. In many embodiments, the embedded editor 404c and output shell 404k are preset within the module 406-3. In certain embodiments, the embedded editor 404c, output shell 404k, and other actionable item or tools may be added to the module 406-3 by a resource provider. The output shell 404k may be dynamically added or launched through application action item 402e. In some embodiments, the editor 404c may take the entire content field 404 and the application action item 402c may toggle between editor 404c and output shell 404k. In certain embodiments, application action item 402e may toggle through other applications or tools within an IDE, for example, interpreter/run tool, debug tool, output shell 404k, and editor 404c.

In some embodiments, application action item 402e may toggle between standard text for the code, and annotated code or visual cues in the editor 404c that displays syntax highlighting, line numbers, autocomplete, error detection, etc. In certain embodiments, application action item 402e may provide a flow diagram for the code (e.g., data entering a function, function provide a result, data outputted or being passed to another function). In certain embodiments, application action item 402e may provide a branch tree that lists functions and direction of flow of data within the editor 404c. In some embodiments, the user interface 401 may include a solution action item 404j that when pressed or activated allows the user to submit their own solution as a file, document, etc. In certain embodiments, the resource provider may set the solution action item 404j to run one or more programs, software, apps, or tools to allow a user to enter and submit their own data as a solution to the question within the software. In some embodiments, a user executing the solution action item 404j may open the tool window 409 and allow the user to provide documents to access other software, programs, apps, or tools to allow a user to enter and submit their own data as a solution to the question.

FIG. 4C illustrates a block diagram of an example user interface for a resource provider to create content for a real-time interactive teaching and learning environment, according to some of the disclosed embodiments. As shown in FIG. 4C, an example graphical user interface for a resource provider (e.g., a question or lesson module customization interface for a resource provider device 234) for creating, for example, content to be distributed in a real-time multi-user interactive teaching and learning environment may be displayed on a display 400 and configured to include a user interface 401 body that includes one or more content fields 404 further including, for example, one or more buttons that include, class or function name 404m, data type 404n, 404p, and attribute or variable name 404p. In some embodiments, these buttons may be displayed on a user screen such that the user may add code, text, or data into the editor 404c by pressing the button. In certain embodiments, the buttons could be used to guide users on answering the question and/or understanding the objective of the question. In some embodiments, the objective may be to create, for example, a function named “calculateArea” with integer variable “radius” and use of another user defined variable having a double data type. In some embodiments, an objective completion item 404q may be displayed above each button to indicate the answer meets the minimum requirements for the question. In some embodiments, the content field may include a button for test cases item 404r. As shown in FIG. 4D, the resource provider may add test cases which the user can use to test their completed code. The resource provider device 234 may be used to add test cases item 404r into one or more content fields 404. The test cases item 404r may be added through, for example, the module editor 406a. In some embodiments, adding the button fo test cases item 404r opens a test case window 407.

FIG. 4D illustrates a block diagram of an example user interface for a resource provider to create content for a real-time interactive teaching and learning environment, according to some of the disclosed embodiments. As shown in FIG. 4D, an example graphical user interface for a resource provider (e.g., a question or lesson module customization interface for a resource provider device 234) for creating, for example, content to be distributed in a real-time multi-user interactive teaching and learning environment may be displayed on a display 400 and configured to include a user interface 401 body that includes one or more test case windows 407. The test case window 407 may include various datatypes and variables that may be defined and used by a user during a user session to test the correctness and/or completeness of their code. In some embodiments, the test case window 407 may populate variables, values, and datatypes already provided on one or more content fields 404. In some embodiments, the resource provider may enter one or more test cases 407a, 408a manually user test case editor 403. In many embodiments, users are required to test each test case 407a, 408a with at least one entry during the user session for the user entered code to be accepted as correct. Referring to FIGS. 4C-4D, for example, a resource provider may define a test case 407a with test entry 407a-1 having a variable “radius” and integer datatype. In certain embodiments, the test entry 407a-1 may be defined and unalterable in the test case window 407, such that during the user session only test case 407a needs to pass for the user answer to be complete and correct. In many embodiments, the test entry 407a-1 may be modifiable in the test case window 407, such that during the user session several values may be required to be entered by the user that must be correct for the user answer to be complete and correct. In some embodiments, both test case 407a and test case 408a must pass when ran with user entered code for the user answer to be complete and correct.

FIG. 4E illustrates a block diagram of an example user interface for a resource provider to create content for a real-time interactive teaching and learning environment, according to some of the disclosed embodiments. As shown in FIG. 4E, an example graphical user interface for a resource provider (e.g., a question or lesson module customization interface for a resource provider device 234) for creating, for example, content to be distributed in a real-time multi-user interactive teaching and learning environment may be displayed on a display 400 and configured to include a user interface 401 body that includes one or more content fields 404. In certain embodiments, as shown in FIG. 4E, the output shell 404k includes the output or result of running the code for a complete answer. For example, the user code when run must output “radius=3” and “Area=28.2743 . . . ” for the response to be accepted as the correct answer. In such case, the user enters code to calculate the area, the test value(s), and print the value(s) and result, as displayed on the output shell 404k to obtain the correct answer.

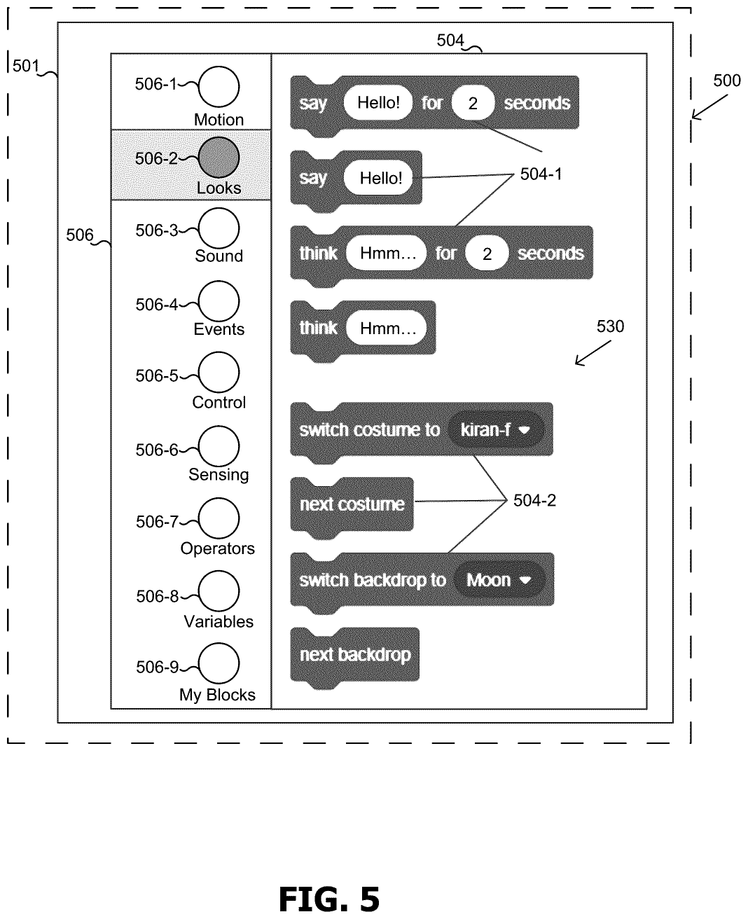

As shown in FIG. 5, an example graphical user interface for a learner (e.g., client computer device 204) may be displayed on a display 500 and configured to include a user interface 501 body that includes one or more content fields 504 having, for example, one or more visual objects 504-1, 504-2 . . . 504-N (hereinafter “504-X”). Each visual object 504-X may provide a step in an overall process or objective to solve a problem, answer a question, build a set of commands, movements, etc., In some embodiments, one or more visual objects 504-X when placed in sequence or connected together in a proper order accomplish a task or objective. For example, a plurality of visual objects 504-X may include words that form a sentence, each visual object must be placed in the right order to form a proper, grammatically correct sentence. As another example, a plurality of visual objects 504-X may include actions, directions, or commands that dictate how an object or character moves, when the correct sequence of directions, commands, or actions are arranged in correct order, the object or character accomplishes a task, completes a problem, or performs movement or dance, for example. In some embodiments, each visual object 504-X may include various forms of input or no input. For example, visual object 504-1 includes fields for text, strings, characters, numbers, commands, directions, etc., when placed in an order the described action in the visual object 504-1 is performed. As another example, visual object 504-2 includes static text that defines an action, as well as a drop down menu to select objects, characters, or parameters defined in the question, game, or quiz, for example. Although a few directives, actions, and controls are defined in one or more control fields 506, many other variations, actions, commands, parameters, operations, and the like may be contemplated and readily applied without departing from the scope of the disclosure. In some embodiments, the control fields 506 may include controls for motion 506-1, object/character/background/foreground properties or looks 506-2, sounds 506-3, events, 506-4, object/character controls 506-5, sensing 506-6, operators 506-7, variables 506-8, and custom blocks as my blocks 506-9. Each control 506-X in the control fields 506 may contain one or more libraries for all related visual objects 504-X corresponding to actions and changes for that control. For example, visual objects 504-2 correspond to actions and changes within the looks control 506-2 library, and visual objects 504-1 correspond to actions and changes within the sound controls 506-2 library.

In some embodiments, controls for motion 506-1 may include fill in the blank and specific motion commands, for example, movement in “left direction” for “20” meters. In some embodiments, the motion commands may include movement that traces a function, for example, move in “sinusoidal” motion for “5” cycles or periods at “low” frequency. In certain embodiments, the motion commands may include, for example, linear, non-linear, curvilinear, or curve motion. The controls for motion need not be specific to an object or character movement, and may include task controls, for example, move “folders” in “D” drive to “E” drive. In some embodiments, one or more visual objects may be configured to include one or more fillable regions for configuring the encapsulated code, for example, switching costume to kiran-f in visual object 504-2. In many embodiments, pre-made blocks of code are provided in each visual object 504-X such that the user can drag and drop these blocks together to form a larger, functional piece of code. Consequently, creating an environment where blocks are added together to create a program similar to an IDE.

Further, each visual object 504-X may encapsulate the explicit code needed to perform the task, sound, motion, function, etc. In many embodiments, users may press, click on, or open each visual object 504-X and investigate the code within that performs the corresponding action or task of that visual object 504-X. Thus, placement of each of the one or more visual objects 504-X in the content field 504 is defined by how that visual object 504-X interacts with preceding visual objects 504-X and proceeding visual objects 504-X. Further, in the example, “next costume” visual object 504-2, the “next costume” may provide a visual inference to users that the “next costume” visual object 504-2 pertains to controls for variables 506-8 object library. Moreover, opening the “next costume” visual object 504-2 may show code, for example, pertaining to accessing the proper libraries for clothing, animation, and shading, etc., and code for going through costumes for a specific character visual object 504-X that is connected to the looks visual object 504-2. In such cases, the user may wish to change the character visual object 504-X, for example, to a different character or object then investigate the proceeding looks visual object 504-2 to investigate how the code changes in the visual object 504-2 for “next costume”. In some embodiments, placement of each of the one or more visual objects 504-X in an active region 530 of the display 500 or user interface 501 runs the corresponding code contained within each of the one or more visual objects 504-X.

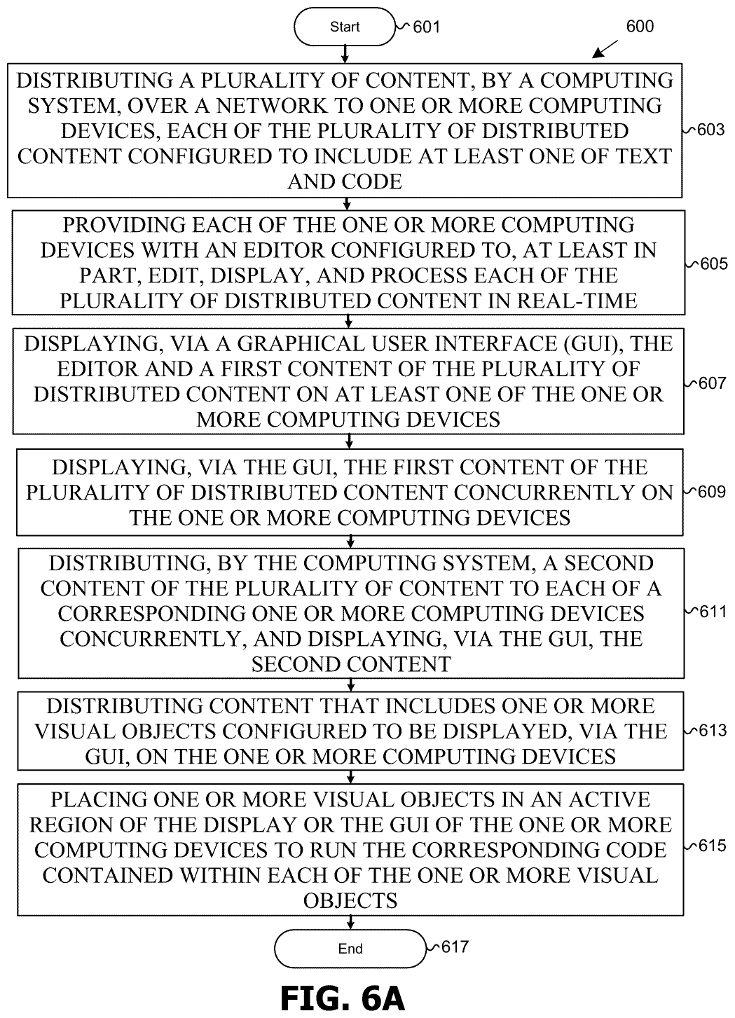

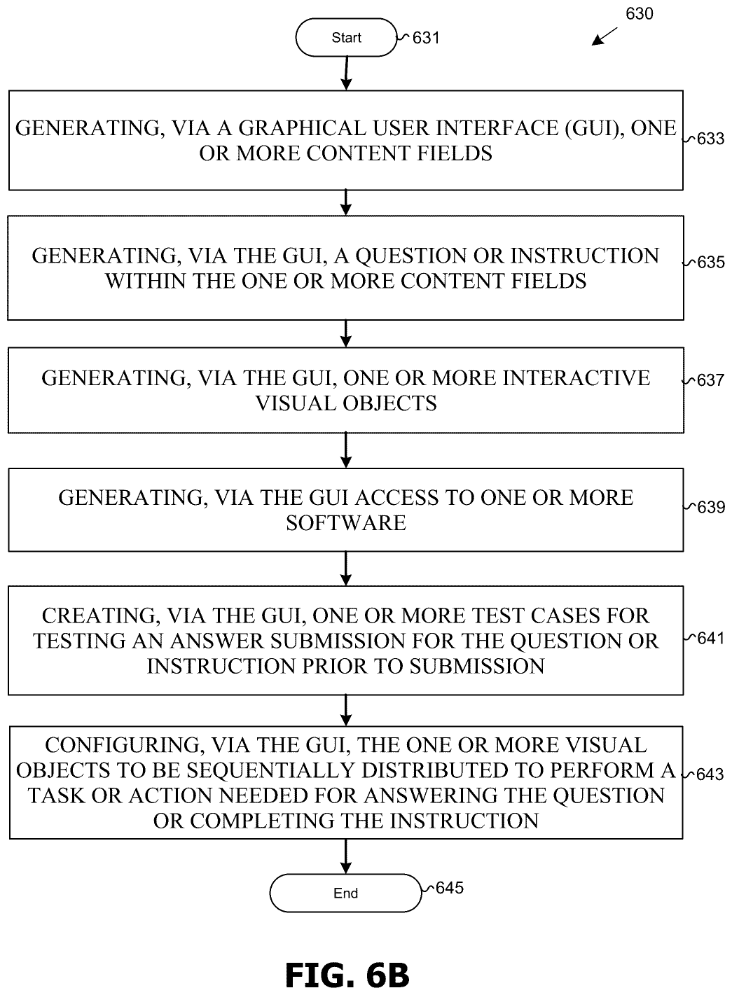

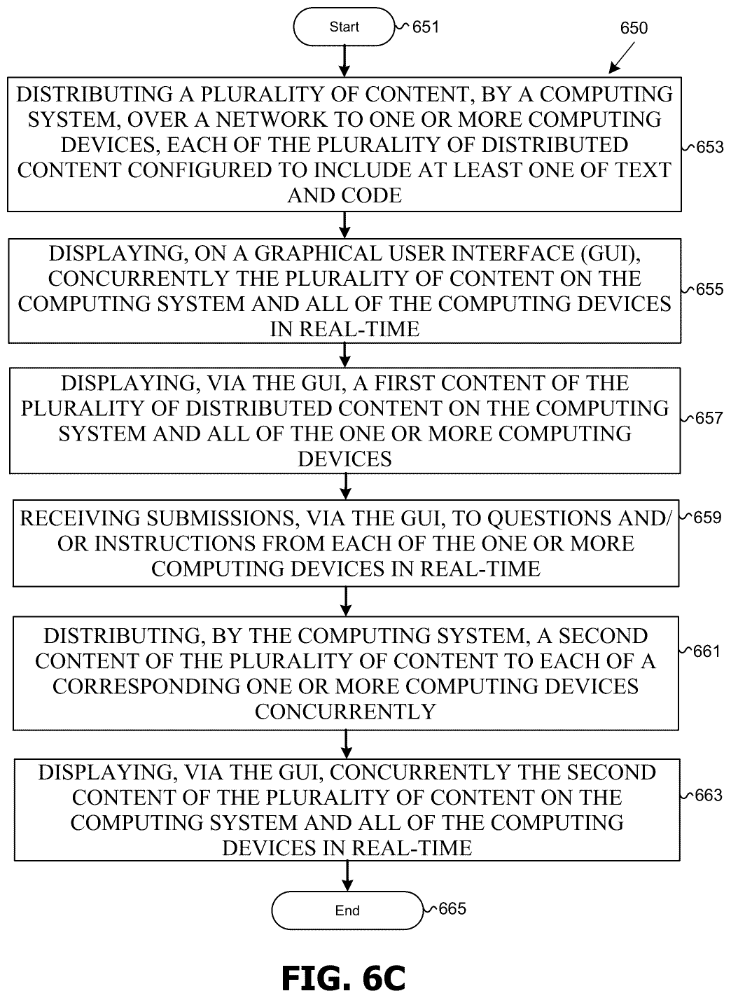

FIG. 6A illustrates an example flow chart showing a method of distributing content for providing real-time interactive teaching and learning environments in accordance with one or more embodiments of the present disclosure. These exemplary methods are provided by way of example, as there are a variety of ways to carry out these methods. Each block shown in FIG. 6A represents one or more processes, methods or subroutines, carried out in the exemplary method. FIGS. 1-5 show example embodiments of carrying out the method of FIG. 6A for user device and resource provider device (or server) interaction for distributing content for providing real-time interactive teaching and learning environments. Each block shown in FIG. 6A represents one or more processes, methods or subroutines, carried out in the exemplary method. The exemplary method may begin at block 601. Method 600 may be used independently or in combination with other methods or process for distributing content for providing real-time interactive teaching and learning environments. For explanatory purposes, the example process 600 is described herein with reference to the real-time interactive teaching and learning environments of FIGS. 1-5. Further for explanatory purposes, the blocks of the example process 600 are described herein as occurring in serial, or linearly. However, multiple blocks of the example process 600 may occur in parallel. In addition, the blocks of the example process 600 may be performed a different order than the order shown and/or one or more of the blocks of the example process 600 may not be performed. Further, any or all blocks of example process 600 may further be combined and done in parallel, in order, or out of order.

In FIG. 6A, the exemplary method 600 of implementing a real-time interactive teaching and learning environment is shown. Method 600 begins at block 601. In block 603, the method includes distributing a plurality of content, by a computing system, over a network to one or more computing devices, each of the plurality of distributed content configured to include at least one of text and code. In some embodiments, a server may be the computing system that distributes the content to one or more computing devices (i.e., server to users). In certain embodiments, a resource provider (an instructor, teach, assistant, tutor, etc.,) may use a computing system to distribute the content to one or more computing devices (i.e., resource provider to users).

In block 605, the method includes providing each of the one or more computing devices with an editor configured to, at least in part, edit, display, and process each of the plurality of distributed content in real-time. In some embodiments, the software, app, tool, program, or the like may be embedded within the graphical user interface of the computing device. In certain embodiments, the editor is configured to include an integrated development environment (IDE), and processing each of the plurality of distributed content in real-time further comprises using the IDE to edit the code within each of the plurality of distributed content, wherein the IDE is configured to provide visual cues to assist in editing the code. In certain embodiments, the editor is configured to include an integrated development environment (IDE), and processing each of the plurality of distributed content in real-time further comprises using the IDE to interpret the code provided in each of the plurality of distributed content.

In block 607, the method includes displaying, via a graphical user interface (GUI), a first content of the plurality of distributed content on at least one of the one or more computing devices. In some embodiments, the first content may be a software, app, tool, program, or the like. In many embodiments, the first content may be text, for example, questions, test cases, etc., In certain embodiments, the first content may be code or other data that may be edited, ran or executed using a graphical user interface of the computing device. In block 609, the method includes displaying, via the GUI, the first content of the plurality of distributed content concurrently on the one or more computing devices. In many embodiments, during a user session, the GUI used to display the plurality of distributed content on the client computing device 204 may be configured to look exactly the same as or similar to the GUI used to create content via a resource provider device 234 or server 240 (e.g., a computing system) to provide a seamless and visually consistent experience between a user or student and an instructor or trainer, for example.

In block 611, the method includes distributing, by the computing system, a second content of the plurality of content to each of a corresponding one or more computing devices concurrently, and displaying, via the GUI, the second content. In many embodiments, the second content is distributed after receiving an input, via the GUI, from a corresponding one or more computing devices, responsive to the first content of the plurality of distributed content by the computing system. In some embodiments, the second content is distributed after initiating a communication, by one or more computing devices, with the computing system to receive, via the GUI, the second content of the plurality of distributed content. In certain embodiments, the second content is distributed after a predetermined amount of time elapses for displaying, via the GUI, the first content of the plurality of distributed content for the corresponding computing device.

In block 613, the method includes distributing content that includes one or more visual objects configured to be displayed, via the GUI, on the one or more computing devices. In block 615, the method includes the placement of each of the one or more visual objects in an active region of the display or the GUI of the one or more computing devices to run the corresponding code contained within each of the one or more visual objects. The method ending in block 617.

FIG. 6B illustrates an example flow chart showing a method of distributing content for providing real-time interactive teaching and learning environments in accordance with one or more embodiments of the present disclosure. These exemplary methods are provided by way of example, as there are a variety of ways to carry out these methods. Each block shown in FIG. 6B represents one or more processes, methods or subroutines, carried out in the exemplary method. FIGS. 1-5 show example embodiments of carrying out the method of FIG. 6B for lesson, content or session creation by a resource provider device (or server). Each block shown in FIG. 6B represents one or more processes, methods or subroutines, carried out in the exemplary method. The exemplary method may begin at block 631. Method 630 may be used independently or in combination with other methods or process for distributing content for providing real-time interactive teaching and learning environments. For explanatory purposes, the example process 630 is described herein with reference to the real-time interactive teaching and learning environments of FIGS. 1-5. Further for explanatory purposes, the blocks of the example process 630 are described herein as occurring in serial, or linearly. However, multiple blocks of the example process 630 may occur in parallel. In addition, the blocks of the example process 630 may be performed a different order than the order shown and/or one or more of the blocks of the example process 630 may not be performed. Further, any or all blocks of example process 630 may further be combined and done in parallel, in order, or out of order.

In FIG. 6B, the exemplary method 630 of implementing a real-time interactive teaching and learning environment is shown. Method 630 begins at block 631. In block 633, the method includes generating, via a graphical user interface (GUI), one or more content fields. In block 635, the method includes generating, via the GUI, a question or instruction within the one or more content fields. In block 637, the method includes generating, via the GUI, one or more interactive visual objects. In certain embodiments, the visual objects provide guidance for answering the question or following the instruction. In some embodiments the visual objects provide a control or action that answers, in part or in whole, the question or instruction.

In block 639, the method includes generating, via the GUI, access to one or more software. In some embodiments, the software is embedded within the content field. In block 641, the method includes creating, via the GUI, one or more test cases for testing an answer submission for the question or instruction prior to submission.

In block 643, the method includes configuring, via the GUI, the one or more visual objects to be sequentially distributed to perform a task or action needed for answering the question or completing the instruction. The method ending in block 645.

FIG. 6C illustrates an example flow chart showing a method of distributing content for providing real-time interactive teaching and learning environments in accordance with one or more embodiments of the present disclosure. These exemplary methods are provided by way of example, as there are a variety of ways to carry out these methods. Each block shown in FIG. 6C represents one or more processes, methods or subroutines, carried out in the exemplary method. FIGS. 1-5 show example embodiments of carrying out the method of FIG. 6C for simultaneous administration of lesson or session by resource provider device (or server) and participation in lesson or session by multi-user real-time participants. Each block shown in FIG. 6C represents one or more processes, methods or subroutines, carried out in the exemplary method. The exemplary method may begin at block 651. Method 650 may be used independently or in combination with other methods or process for distributing content for providing real-time interactive teaching and learning environments. For explanatory purposes, the example process 650 is described herein with reference to the real-time interactive teaching and learning environments of FIGS. 1-5. Further for explanatory purposes, the blocks of the example process 650 are described herein as occurring in serial, or linearly. However, multiple blocks of the example process 650 may occur in parallel. In addition, the blocks of the example process 650 may be performed a different order than the order shown and/or one or more of the blocks of the example process 650 may not be performed. Further, any or all blocks of example process 650 may further be combined and done in parallel, in order, or out of order.

In FIG. 6C, the exemplary method 650 of implementing a real-time interactive teaching and learning environment is shown. Method 650 begins at block 651. In block 653, the method includes distributing a plurality of content, by a computing system, over a network to one or more computing devices, each of the plurality of distributed content configured to include at least one of text and code. In some embodiments, the computing system may be one or more resource provider devices 234. In certain embodiments, the computing system may be one or more servers 240.

In block 655, the method includes displaying, on a graphical user interface (GUI), concurrently the plurality of content on the computing system and all of the computing devices in real-time. In block 657, the method includes displaying, via the GUI, a first content of the plurality of distributed content on the computing system and all of the one or more computing devices. In certain embodiments, the distributed content is provided in real-time by the computing system to all of the one or more computing devices. In many embodiments, during a user session, the GUI used to display the plurality of distributed content on the client computing device 204 may be configured to look exactly the same as or similar to the GUI used to create content via a resource provider device 234 or server 240 (e.g., a computing system) to provide a seamless and visually consistent experience between a user or student and an instructor or trainer, for example.

In block 659, the method includes receiving submissions, via the GUI, to questions and/or instructions from each of the one or more computing devices in real-time. In many embodiments, the computing system receives all responses and/or inputs in real-time from one or more computing devices. In block 661, the method includes distributing, by the computing system, a second content of the plurality of content to each of a corresponding one or more computing devices concurrently. In block 663, the method includes displaying, via the GUI, concurrently the second content of plurality of content on the computing system and all of the computing devices in real-time. The method ending in block 665.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

The term “code” and “coding”, also known as programming, is the process of creating, designing, testing, and maintaining computer software by writing and organizing instructions in a programming language. These instructions, called code, are designed to be executed by a computer or other programmable device to perform specific tasks, solve problems, or automate processes. Coding involves understanding the syntax, semantics, and logic of a programming language, as well as employing problem-solving skills, creativity, and critical thinking to achieve desired outcomes.

An Integrated Development Environment (IDE) may be the environment used to write code. Although IDE is disclosed and described in the embodiments, the disclosure should not be limited to on IDE implementations, and various other editors or programs and applications that implement interpret, run, execute, compile, debug and output shell functions as well as other functions may be use in any of the embodiments disclosed above. Further software developer tools may also be instantiated by any of the above embodiments as opposed to a built-in IDE within the editor to allow a user, server or computing device to select and provide a tool, application, or programming environment that may be more familiar to the user outside of a real-time interactive environment.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising.” when utilized, means “including, but not necessarily limited to”; it specifically indicates open-ended inclusion or membership in the so-described combination, group, series and the like.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method, comprising:
distributing a plurality of content, by a computing system, over a network to one or more computing devices, each of the plurality of distributed content configured to include at least one of text and code;
providing each of the one or more computing devices with an editor configured to, at least in part, edit, display, and process each of the plurality of distributed content in real-time; and
displaying, via a graphical user interface (GUI), the editor and a first content of the plurality of distributed content on at least one of the one or more computing devices;
wherein the first content of the plurality of distributed content is displayed, on the GUI, concurrently on the one or more computing devices.

2. The method of claim 1, further comprising distributing, by the computing system, a second content of the plurality of content to each of a corresponding one or more computing devices concurrently, and displaying, via the GUI, the second content, after at least one of:
receiving an input, via the GUI, from a corresponding one or more computing devices, responsive to the first content of the plurality of distributed content by the computing system, or
initiating a communication, by one or more computing devices, with the computing system to receive, via the GUI, the second content of the plurality of distributed content, or
a predetermined amount of time elapses for displaying, via the GUI, the first content of the plurality of distributed content for the corresponding computing device.

3. The method of claim 1, wherein the editor is configured to include an integrated development environment (IDE), and processing each of the plurality of distributed content in real-time further comprises using the IDE to edit the code within each of the plurality of distributed content, wherein the IDE is configured to provide visual cues to assist in editing the code.

4. The method of claim 1, wherein the editor is configured to include an integrated development environment (IDE), and processing each of the plurality of distributed content in real-time further comprises using the IDE to interpret the code provided in each of the plurality of distributed content.

5. The method of claim 4, wherein each of the plurality of content further comprises a question, each of the one or more computing devices obtains and displays, via the GUI, the same question concurrently, and the editor is configured to, via the GUI, display, edit and compile the provided code in each question.

6. The method of claim 1, wherein at least one of the one or more computing devices is configured to display, via the GUI, the distributed content and at least one of: a file manager and access to the editor.

7. The method of claim 1, wherein one or more portions of the code are provided as one or more visual objects, wherein each of the one or more visual objects is configured to be displayed, via the GUI, on the one or more computing devices, wherein placement of each of the one or more visual objects in an active region of the display of the one or more computing devices runs the corresponding code contained within each of the one or more visual objects placed on the active region of the display.

8. The method of claim 1, wherein the plurality of content further comprises one or more visual objects, wherein the code is contained within the one or more visual objects, and wherein each of the one or more visual objects is configured to be displayed, via the GUI, on the one or more computing devices, and wherein placement of each of the one or more visual objects in an active region of the display of the one or more computing devices runs the contained code on the one or more computing devices.

9. The method of claim 8, wherein at least one of the one or more visual objects displayed, via the GUI, on the one or more computing devices further comprises one or more fillable regions for configuring the code.

10. A non-transitory computer-readable medium comprising instructions stored therein, which, when executed by one or more processors of a processing system cause the one or more processors to perform operations comprising:
distributing a plurality of content, by a computing system, over a network to one or more computing devices, each of the plurality of distributed content configured to include at least one of text and code;
providing each of the one or more computing devices with an editor configured to, at least in part, edit, display, and process each of the plurality of distributed content in real-time; and
displaying, via a graphical user interface (GUI), the editor and a first content of the plurality of distributed content on at least one of the one or more computing devices;
wherein the first content of the plurality of distributed content is displayed, on the GUI, concurrently on the one or more computing devices.

11. The non-transitory computer-readable medium of claim 10, further comprising distributing, by the computing system, a second content of the plurality of content to each of a corresponding one or more computing devices concurrently, and displaying, via the GUI, the second content, after at least one of:
receiving an input, via the GUI, from a corresponding one or more computing devices, responsive to the first content of the plurality of distributed content by the computing system, or
initiating a communication, by one or more computing devices, with the computing system to receive, via the GUI, the second content of the plurality of distributed content, or
a predetermined amount of time elapses for displaying, via the GUI, the first content of the plurality of distributed content for the corresponding computing device.

12. The non-transitory computer-readable medium of claim 10, wherein the editor is configured to include an integrated development environment (IDE), and processing each of the plurality of distributed content in real-time further comprises using the IDE to edit the code within each of the plurality of distributed content, wherein the IDE is configured to provide visual cues to assist in editing the code.

13. The non-transitory computer-readable medium of claim 10, wherein the editor is configured to include an integrated development environment (IDE), and processing each of the plurality of distributed content in real-time further comprises using the IDE to interpret the code provided in each of the plurality of distributed content.

14. The non-transitory computer-readable medium of claim 13, wherein each of the plurality of content further comprises a question, each of the one or more computing devices obtains and displays, via the GUI, the same question concurrently, and the editor is configured to, via the GUI, display, edit and compile the provided code in each question.

15. The non-transitory computer-readable medium of claim 10, wherein one or more portions of the code are provided as one or more visual objects, wherein each of the visual objects is configured to be displayed, via the GUI, on the one or more computing devices, wherein placement of each of the one or more visual objects in an active region of the display of the one or more computing devices runs the corresponding code contained within each of the one or more visual objects placed on the active region of the display.

16. The non-transitory computer-readable medium of claim 15, further comprising providing information, by the computing system, to at least one of the one or more computing devices for generating a graphical user interface (GUI), the GUI being configured to include an editor for displaying code in textual format or as one or more visual objects.

17. A computing system comprising:
a network module, the network module configured to communicable couple to one or more computing devices;
a processor; and
memory in communication with the processor and storing instructions that, when executed by the processor, cause the computing system to:
retrieve a plurality of content from a database, the plurality of content configured to include at least one of text and code; and
distribute the plurality of content to the one or more computing devices, wherein each of the plurality of distributed content is displayed on at least one of the one or more computing devices;
wherein each of the plurality of distributed content is displayed, via a graphical user interface (GUI), concurrently on the one or more computing devices; and
wherein each of the one or more computing devices includes an editor, displayed via the GUI, and configured to, at least in part, edit, display, and process each of the plurality of distributed content in real-time.

18. The computing system of claim 17, wherein the editor is configured to include an integrated development environment (IDE) configured to edit the code within each of the plurality of distributed content in real-time, wherein the IDE is configured to provide visual cues to assist in editing the code.

19. The computing system of claim 18, wherein each of the plurality of content further comprises a question, each of the one or more computing devices obtains and displays, via the GUI, the same question concurrently, and the editor is configured to, via the GUI, display, edit and compile the provided code in each question.

20. The computing system of claim 17, wherein one or more portions of the code are provided as one or more visual objects, wherein each of the visual objects is configured to be displayed, via the GUI, on the one or more computing devices, wherein placement of each of the one or more visual objects in an active region of the display of the one or more computing devices runs the corresponding code contained within each of the one or more visual objects placed on the active region of the display.
